(19) United States
(12) Patent Application Publication
(10) Pub. No.: US 2023/0317017 A1
(43) Pub. Date: Oct. 5, 2023

(54) GROUPED DISPLAY GATE SCANNING IN FOVEATED RESOLUTION DISPLAYS

(71) Applicant: Meta Platforms Technologies, LLC, Menlo Park, CA (US)

(72) Inventors: Yongman Lee, Sunnyvale, CA (US); Qianqian Wang, Santa Clara, CA (US)

(21) Appl. No.: 18/125,711

(22) Filed: Mar. 23, 2023

Related U.S. Application Data
(60) Provisional application No. 63/326,641, filed on Apr. 1, 2022.

(51) Int. Cl. G09G 3/3266; G09G 3/3233

(52) U.S. Cl. CPC G09G 3/3266; G09G 3/3233; G09G 2300/0852; G09G 2310/08; G09G 2310/0213; G09G 2310/0286; G09G 2330/021

(57) ABSTRACT

Embodiments relate to a display device having a display area with a plurality of rows of pixels. Multiple rows of the display area may be grouped such that data is written to the pixels of all rows of the grouping concurrently. Each row includes a respective gate scan driver circuit coupled to the gate line of the row, and to a gate scan line configured to sequentially provide an enable pulse to gate scan driver circuits of the plurality of rows over a plurality of time periods. The gate scan driver circuit selectively provides the enable pulse provided by the gate scan line or a gate enable signal of a gate line of an adjacent row as a gate enable signal to the gate line of the respective row, based upon a predetermined grouping of rows of the display device.

### CROSS REFERENCE TO RELATED APPLICATIONS

This application claims a priority and benefit to U.S. Provisional Patent Application Ser. No. 63/326,641, filed Apr. 1, 2022, which is hereby incorporated by reference in its entirety.

### BACKGROUND

This disclosure relates to a display device, and specifically to a silicon based organic light emitting diode (OLED) display having configurable resolution.

A display device is often used in a virtual reality (VR) or augmented-reality (AR) system as a head-mounted display (HMD) or a near-eye display (NED). To display high resolution images, it is beneficial to increase the number of pixels in the display device and operate the display device with a higher frame rate. However, when there is an increased number of pixels in a display device being operated at a higher frame rate, time allocated for preparing and writing of data to pixels are reduced. In addition, utilization of an increased number of pixels may result in higher charging frequency, increasing power consumption.

### SUMMARY

In some aspects, the techniques described herein relate to a display device including: a display area including a plurality of pixels arranged in a plurality of rows, each row including a respective gate line configured to provide a gate enable signal to pixels of the row; a plurality of gate scan driver circuits, each coupled to a gate line of a respective row of the plurality of rows, and to a gate scan line configured to sequentially provide an enable pulse to gate scan driver circuits of the plurality of gate scan driver circuits over a plurality of time periods, and configured to selectively provide the enable pulse provided by the gate scan line or a gate enable signal of a gate line of an adjacent row of the plurality of rows as a gate enable signal to the gate line of the respective row, based upon a predetermined grouping of rows of the display device.

In some aspects, the techniques described herein relate to a method of operating a display device, including: at a display driver integrated circuit (DDIC) of a display device, where the display device includes a display area including a plurality of pixels arranged in a plurality of rows each having a respective gate line coupled to a respective gate scan driver circuit, receiving data indicating a grouping of rows of the display area; at the DDIC, configuring gate scanning signals based on the grouping of rows, wherein values of the gate scanning signals are timed based on a timing of an enable pulse provided by a gate scan line sequentially to gate scan driver circuits of the plurality of rows of the display area; at the DDIC, configuring a timing of selection pulses based on the grouping of rows and the timing of the enable pulse provided by the gate scan line; operating the displaying by providing the enable pulse sequentially to the plurality of rows via the gate scan line, in conjunction with the configured gate scanning signals and selection pulses, wherein each gate scan driver circuit coupled to a gate line of a respective row of the plurality of rows is configured to selectively provide the enable pulse provided by the gate scan line or a gate enable signal of a gate line of an adjacent row of the plurality of rows as a gate enable signal to the gate line of the respective row, based upon at least a portion of the configured gate scanning signals provided via one or more gate control lines of a plurality of gate control lines.

### BRIEF DESCRIPTION OF DRAWINGS

Figures (FIGS. 1A and 1B are diagrams of head-mounted displays (HMDs) that include near-eye displays (NED), according to some embodiments.

FIG. 2 is a cross-sectional view of the HMD illustrated in FIG. 1A or 1B, according to some embodiments.

FIG. 3 illustrates a perspective view of a waveguide display, according to some embodiments.

FIG. 4 depicts a simplified organic light emitting diode (OLED) structure, according to some embodiments.

FIG. 5 is a schematic view of an OLED display device architecture including a display driver integrated circuit (DDIC), according to some embodiments.

FIG. 6 is a schematic view of an OLED display device, according to some embodiments.

FIG. 7A illustrates an example pixel arrangement of a display device, according to some embodiments.

FIG. 7B is a circuit diagram of a pixel with four transistors and two capacitors, according to some embodiments.

FIG. 8 illustrates a high level diagram showing implementation of a foveated display, in accordance with some embodiments.

FIG. 9 illustrates a diagram of a gate scan driver for a row of the display panel, in accordance with some embodiments.

FIG. 10A illustrates a full multiplexer implementation of the enable select circuit for a set for rows, in accordance with some embodiments.

FIG. 10B illustrates a half multiplexer implementation of the enable select circuit for a set for rows, in accordance with some embodiments.

FIG. 10C illustrates a table showing control signal configurations for the gate control lines GS0 through GS3 that may be used to enable different groupings of rows using the gate enable circuits shown in FIGS. 10A and/or 10B, in accordance with some embodiments.

FIGS. 11A and 11B illustrate example timing diagrams showing control signals used for grouping different combinations of rows of a display, in accordance with some embodiments.

FIG. 12A illustrates a diagram of a bidirectional enable select circuit utilizing a directional signal line, in accordance with some embodiments.

FIG. 12B illustrates a diagram of a bidirectional enable select circuit without utilizing a directional signal line, in accordance with some embodiments.

FIG. 12C illustrates a table showing control signal configurations for the gate control lines GS[3:0] that may be used to enable different groupings of rows using the gate enable circuits shown in FIG. 12A or 12B, in accordance with some embodiments.

FIGS. 13A-13D illustrate example timing diagrams showing control signals for grouping different combinations of rows of a display, in accordance with some embodiments.

FIG. 14A illustrates another diagram of bidirectional enable select circuits for a set of rows, in accordance with some embodiments.

FIG. 14B illustrates a table showing control signal configurations for the gate control lines GS[3:0] that may be used to enable different groupings of rows using the gate enable circuits shown in FIG. 14A, in accordance with some embodiments.

FIGS. 15A-15D illustrate example timing diagrams showing control signals for grouping different combinations of rows of a display, using the enable select circuits illustrated in FIG. 14A, in accordance with some embodiments.

FIG. 16A illustrates another diagram of bidirectional enable select circuits for a set of rows, in accordance with some embodiments.

FIG. 16B illustrates a table showing control signal configurations for the gate control lines GS[3:0] that may be used to enable different groupings of rows using the gate enable circuits shown in FIG. 14A, in accordance with some embodiments.

FIG. 17 illustrates an example timing diagram with control signals for grouping rows of a display, in accordance with some embodiments.

FIG. 18 is a flowchart illustrating a method of configuring a display to perform grouped gate scanning for a display device, according to some embodiments.

The figures depict embodiments of the present disclosure for purposes of illustration only.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, the described embodiments may be practiced without these specific details. In other instances, well-known methods, procedures, components, circuits, and networks have not been described in detail so as not to unnecessarily obscure aspects of the embodiments.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

Figures (FIGS. 1A and 1B are diagrams of head-mounted displays (HMDs) 100 that include near-eye displays (NED) 110, according to some embodiments. The NED 110 may present media to a user. Examples of media that may be presented by the NED 110 include one or more images, video, audio, or some combination thereof. In some embodiments, audio may be presented via an external device (e.g., speakers and/or headphones) that receives audio information from the HMD 100, a console (not shown), or both, and presents audio data to the user based on the audio information. The HMD 100 is generally configured to operate as a virtual reality (VR) HMD. However, in some embodiments, the HMD 100 may be modified to also operate as an augmented reality (AR) HMD, a mixed reality (MR) HMD, or some combination thereof. For example, in some embodiments, the HMD 100 may augment views of a physical, real-world environment with computer-generated elements (e.g., still images, video, sound, etc.).

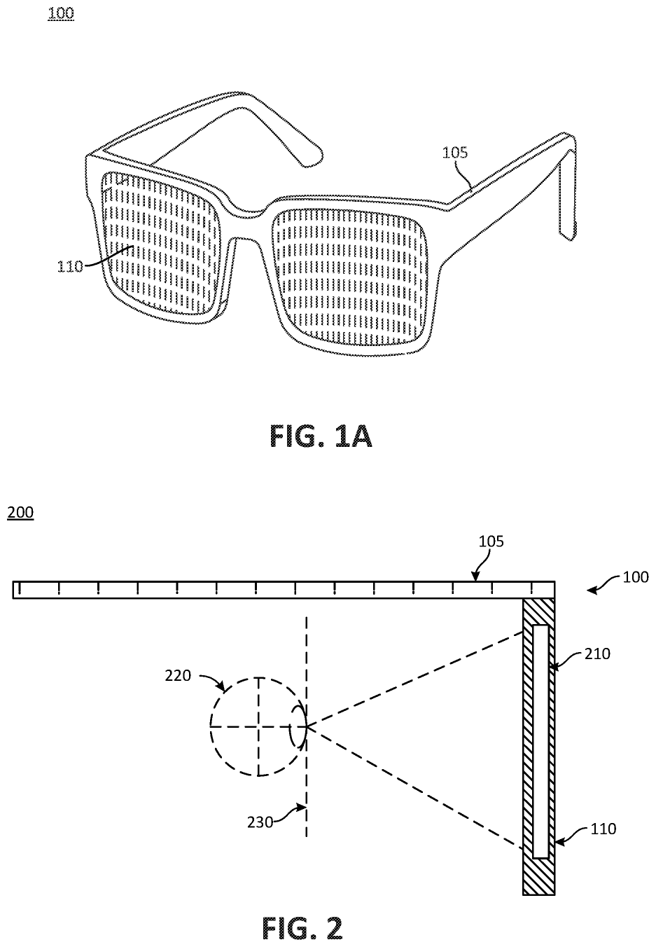

The HMD 100 shown in FIG. 1A or 1B may include a frame 105 and a display 110. The frame 105 may include one or more optical elements that together display media to a user. That is, the display 110 may be configured for a user to view the content presented by HMD 100. As discussed below in conjunction with FIG. 2, the display 110 may include at least one source assembly to generate image light to present optical media to an eye of the user. The source assembly may include, e.g., a source, an optics system, or some combination thereof.

FIGS. 1A and 1B are merely examples of a virtual reality system, and the display systems described herein may be incorporated into further such systems.

FIG. 2 is a cross section 200 of the HMD 100 illustrated in FIG. 1A or 1B, in accordance with some embodiments of the present disclosure. The cross section 200 may include at least one display assembly 210, and an exit pupil 230. The exit pupil 230 is a location where the eye 220 may be positioned when the user wears the HMD 100. In some embodiments, the frame 105 may represent a frame of eye-wear glasses. For purposes of illustration, FIG. 2 shows the cross section 200 associated with a single eye 220 and a single display assembly 210, but in alternative embodiments not shown, another display assembly that is separate from or integrated with the display assembly 210 shown in FIG. 2, may provide image light to another eye of the user.

The display assembly 210 may direct the image light to the eye 220 through the exit pupil 230. The display assembly 210 may be composed of one or more materials (e.g., plastic, glass, etc.) with one or more refractive indices that effectively decrease the weight and widen a field of view of the HMD 100.

In alternate configurations, the HMD 100 may include one or more optical elements (not shown) between the display assembly 210 and the eye 220. The optical elements may act to, by way of various examples, correct aberrations in image light emitted from the display assembly 210, magnify image light emitted from the display assembly 210, perform some other optical adjustment of image light emitted from the display assembly 210, or combinations thereof. Example optical elements may include an aperture, a Fresnel lens, a convex lens, a concave lens, a filter, or any other suitable optical element that may affect image light.

In some embodiments, the display assembly 210 may include a source assembly to generate image light to present media to a user's eyes. The source assembly may include, e.g., a light source, an optics system, or some combination thereof. In accordance with various embodiments, a source assembly may include a light-emitting diode (LED) such as an organic light-emitting diode (OLED), or other type of LED. In some embodiments, the source assembly may correspond to other types of displays in which pixels are arranged in rows and columns, and connected to respective gate and data lines, such as a liquid crystal display (LCD).

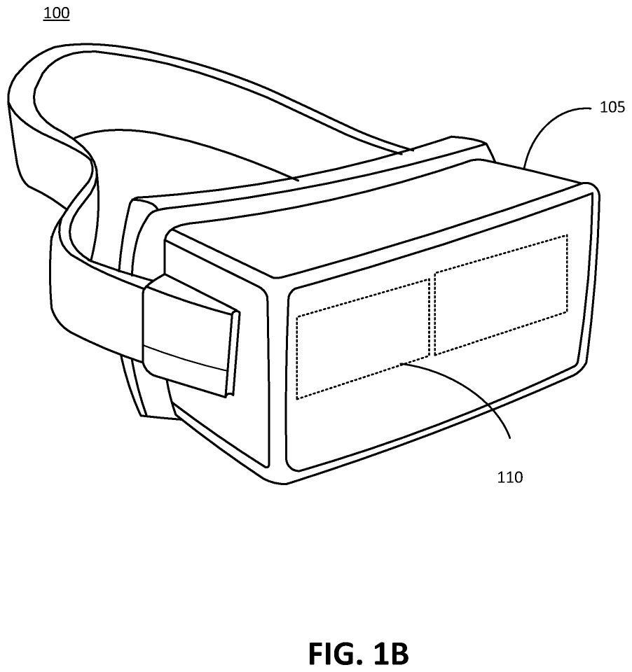

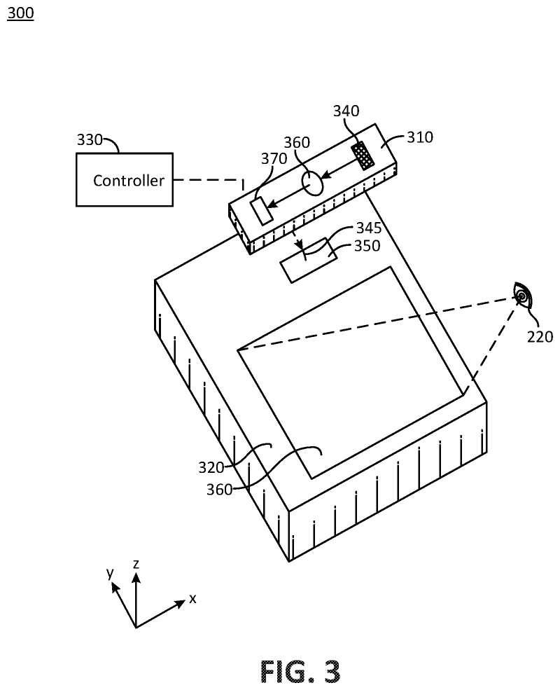

FIG. 3 illustrates a perspective view of a waveguide display 300 in accordance with some embodiments. The waveguide display 300 may be a component (e.g., display assembly 210) of HMD 100. In alternate embodiments, the waveguide display 300 may constitute a part of some other HMD, or other system that directs display image light to a particular location.

The waveguide display 300 may include, among other components, a source assembly 310, an output waveguide 320, and a controller 330. For purposes of illustration, FIG. 3 shows the waveguide display 300 associated with a single eye 220, but in some embodiments, another waveguide display separate (or partially separate) from the waveguide display 300 may provide image light to another eye of the user. In a partially separate system, for instance, one or more components may be shared between waveguide displays for each eye.

The source assembly 310 generates image light. The source assembly 310 may include a source 340, a light conditioning assembly 360, and a scanning mirror assembly 370. The source assembly 310 may generate and output image light 345 to a coupling element 350 of the output waveguide 320.

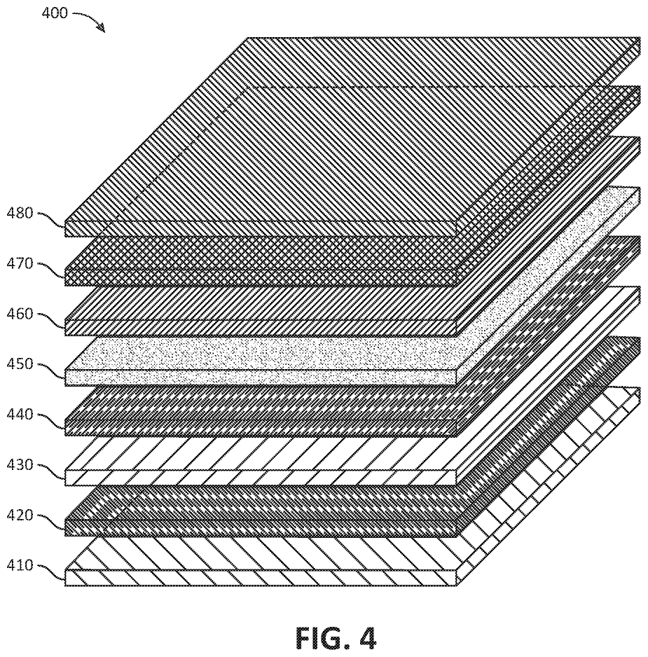

The source 340 may include a source of light that generates at least a coherent or partially coherent image light 345. The source 340 may emit light in accordance with one or more illumination parameters received from the controller 330. The source 340 may include one or more source elements, including, but not restricted to light emitting diodes, such as micro-OLEDs (uOLEDs), as described in detail below with reference to FIGS. 4-7B. While the below description primarily describes the source 340 as comprising OLEDs and/or micro-OLEDs, it is understood that in other embodiments, the source 340 may comprise other types of source elements, such as micro-LEDs or an LCD.

The output waveguide 320 may be configured as an optical waveguide that outputs image light to an eye 220 of a user. The output waveguide 320 receives the image light 345 through one or more coupling elements 350 and guides the received input image light 345 to one or more decoupling elements 360. In some embodiments, the coupling element 350 couples the image light 345 from the source assembly 310 into the output waveguide 320. The coupling element 350 may be or include a diffraction grating, a holographic grating, some other element that couples the image light 345 into the output waveguide 320, or some combination thereof. For example, in embodiments where the coupling element 350 is a diffraction grating, the pitch of the diffraction grating may be chosen such that total internal reflection occurs, and the image light 345 propagates internally toward the decoupling element 360. For example, the pitch of the diffraction grating may be in the range of approximately 300 nm to approximately 600 nm.

The decoupling element 360 decouples the total internally reflected image light from the output waveguide 320. The decoupling element 360 may be or include a diffraction grating, a holographic grating, some other element that decouples image light out of the output waveguide 320, or some combination thereof. For example, in embodiments where the decoupling element 360 is a diffraction grating, the pitch of the diffraction grating may be chosen to cause incident image light to exit the output waveguide 320. An orientation and position of the image light exiting from the output waveguide 320 may be controlled by changing an orientation and position of the image light 345 entering the coupling element 350.

The output waveguide 320 may be composed of one or more materials that facilitate total internal reflection of the image light 345. The output waveguide 320 may be composed of, for example, silicon, glass, or a polymer, or some combination thereof. The output waveguide 320 may have a relatively small form factor such as for use in a head-mounted display. For example, the output waveguide 320 may be approximately 30 mm wide along an x-dimension, 50 mm long along a y-dimension, and 0.5-1 mm thick along a z-dimension. In some embodiments, the output waveguide 320 may be a planar (2D) optical waveguide.

The controller 330 may be used to control the scanning operations of the source assembly 310. In certain embodiments, the controller 330 may determine scanning instructions for the source assembly 310 based at least on one or more display instructions. Display instructions may include instructions to render one or more images. In some embodiments, display instructions may include an image file (e.g., bitmap). The display instructions may be received from, e.g., a console of a virtual reality system (not shown). Scanning instructions may include instructions used by the source assembly 310 to generate image light 345. The scanning instructions may include, e.g., a type of a source of image light (e.g. monochromatic, polychromatic), a scanning rate, an orientation of scanning mirror assembly 370, and/or one or more illumination parameters, etc. The controller 330 may include a combination of hardware, software, and/or firmware not shown here so as not to obscure other aspects of the disclosure.

According to some embodiments, source 340 may include a light emitting diode (LED), such as an organic light emitting diode (OLED). An organic light-emitting diode (OLED) is a light-emitting diode (LED) having an emissive electroluminescent layer that may include a thin film of an organic compound that emits light in response to an electric current. The organic layer is typically situated between a pair of conductive electrodes. One or both of the electrodes may be transparent.

As will be appreciated, an OLED display can be driven with a passive-matrix (PMOLED) or active-matrix (AMOLED) control scheme. In a PMOLED scheme, each row (and line) in the display may be controlled sequentially, whereas AMOLED control typically uses a thin-film transistor backplane to directly access and switch each individual pixel on or off, which allows for higher resolution and larger display areas.

In other embodiments, the OLED display is embodied as part of a display panel that does not include any waveguide. The OLED display may be a screen that is viewable directly by to the user's eye instead of passing light through a waveguide.

FIG. 4 depicts a simplified OLED structure according to some embodiments. As shown in an exploded view, OLED 400 may include, from bottom to top, a substrate 410, anode 420, hole injection layer 430, hole transport layer 440, emissive layer 450, blocking layer 460, electron transport layer 470, and cathode 480. In some embodiments, substrate (or backplane) 410 may include single crystal or polycrystalline silicon or other suitable semiconductor (e.g., germanium).

Anode 420 and cathode 480 may include any suitable conductive material(s), such as transparent conductive oxides (TCOs, e.g., indium tin oxide (ITO), zinc oxide (ZnO), and the like). The anode 420 and cathode 480 are configured to inject holes and electrons, respectively, into one or more organic layer(s) within emissive layer 450 during operation of the device.

The hole injection layer 430, which is disposed over the anode 420, receives holes from the anode 420 and is configured to inject the holes deeper into the device, while the adjacent hole transport layer 440 may support the transport of holes to the emissive layer 450. The emissive layer 450 converts electrical energy to light. Emissive layer 450 may include one or more organic molecules, or light-emitting fluorescent dyes or dopants, which may be dispersed in a suitable matrix as known to those skilled in the art.

Blocking layer 460 may improve device function by confining electrons (charge carriers) to the emissive layer 450. Electron transport layer 470 may support the transport of electrons from the cathode 480 to the emissive layer 450.

In some embodiments, the generation of red, green, and blue light (to render full-color images) may include the formation of red, green, and blue OLED sub-pixels in each pixel of the display. Alternatively, the OLED 400 may be adapted to produce white light in each pixel. The white light may be passed through a color filter to produce red, green, and blue sub-pixels.

Any suitable deposition process(es) may be used to form OLED 400. For example, one or more of the layers constituting the OLED may be fabricated using physical vapor deposition (PVD), chemical vapor deposition (CVD), evaporation, spray-coating, spin-coating, atomic layer deposition (ALD), and the like. In further aspects, OLED 400 may be manufactured using a thermal evaporator, a sputtering system, printing, stamping, etc.

According to some embodiments, OLED 400 may be a micro-OLED. A “micro-OLED,” in accordance with various examples, may refer to a particular type of OLED having a small active light emitting area (e.g., less than 2,000 μm2 in some embodiments, less than 20 μm2 or less than 10 μm2 in other embodiments). In some embodiments, the emissive surface of the micro-OLED may have a diameter of less than approximately 2 μm. Such a micro-OLED may also have collimated light output, which may increase the brightness level of light emitted from the small active light emitting area.

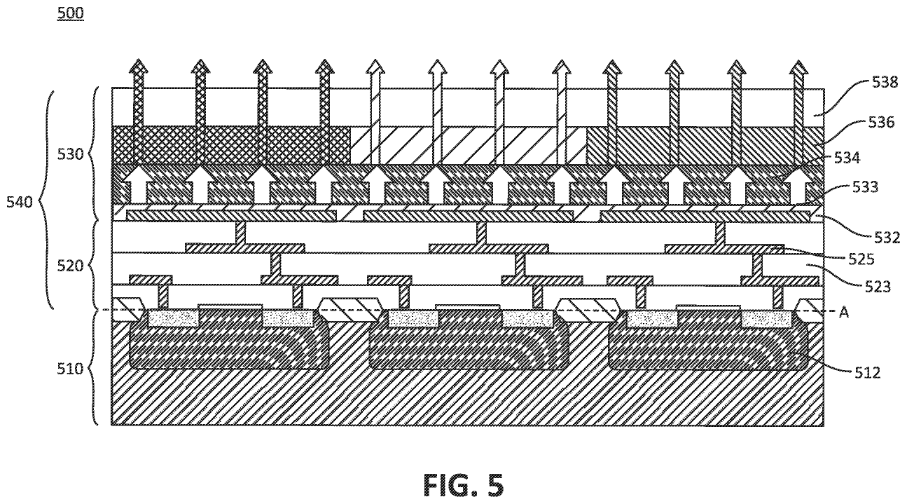

FIG. 5 is a schematic view of an OLED display device architecture including a display driver integrated circuit (DDIC) 510 according to some embodiments. According to some embodiments, OLED display device 500 (e.g., micro-OLED chip) may include an active display area 530 having an active matrix 532 (such as OLED 400) disposed over a single crystal (e.g., silicon) backplane 520. The combined display/backplane architecture, i.e., display element 540 may be bonded (e.g., at or about interface A) directly or indirectly to the DDIC 510. As illustrated in FIG. 5, DDIC 510 may include an array of driving transistors 512, which may be formed using conventional CMOS processing. One or more display driver integrated circuits may be formed over a single crystal (e.g., silicon) substrate.

In some embodiments, the active display area 530 may have at least one areal dimension (i.e., length or width) greater than approximately 1.3 inches, e.g., approximately 1.4, 1.5, 1.6, 1.7, 1.8, 1.9, 2.0, 2.25, 2.5, 2.75, or 3 inches, including ranges between any of the foregoing values, although larger area displays are contemplated.

Backplane 520 may include a single crystal or polycrystalline silicon layer 523 having a through silicon via 525 for electrically connecting the DDIC 510 with the active display area 530. In some embodiments, active display area 530 may further include a transparent encapsulation layer 534 disposed over an upper emissive surface 533 of active matrix 532, a color filter 536, and cover glass 538.

According to various embodiments, the active display area 530 and underlying backplane 520 may be manufactured separately from, and then later bonded to, DDIC 510, which may simplify formation of the OLED active area, including formation of the active matrix 532, color filter 536, etc.

The DDIC 510 may be directly bonded to a back face of the backplane opposite to active matrix 532. In further embodiments, a chip-on-flex (COF) packaging technology may be used to integrate display element 540 with DDIC 510, optionally via a data selector (i.e., multiplexer) array (not shown) to form OLED display device 500. As used herein, the terms “multiplexer” or “data selector” may, in some examples, refer to a device adapted to combine or select from among plural analog or digital input signals, which are transmitted to a single output. Multiplexers may be used to increase the amount of data that can be communicated within a certain amount of space, time, and bandwidth.

As used herein, “chip-on-flex” (COF) may, in some examples, refer to an assembly technology where a microchip or die, such as an OLED chip, is directly mounted on and electrically connected to a flexible circuit, such as a direct driver circuit. In a COF assembly, the microchip may avoid some of the traditional assembly steps used for individual IC packaging. This may simplify the overall processes of design and manufacture while improving performance and yield.

In accordance with certain embodiments, assembly of the COF may include attaching a die to a flexible substrate, electrically connecting the chip to the flex circuit, and encapsulating the chip and wires, e.g., using an epoxy resin to provide environmental protection. In some embodiments, the adhesive (not shown) used to bond the chip to the flex substrate may be thermally conductive or thermally insulating. In some embodiments, ultrasonic or thermosonic wire bonding techniques may be used to electrically connect the chip to the flex substrate.

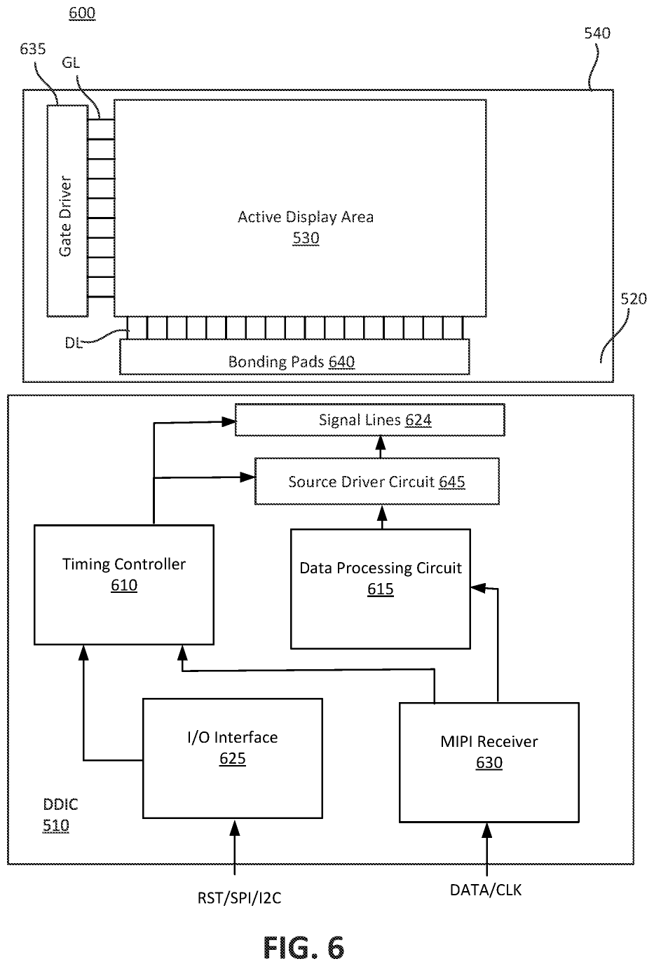

FIG. 6 is a schematic view of an OLED display device 600 according to some embodiments. The OLED display device 600 may include, among other components, the DDIC 510 and the display element 540. The display element 540 may be an integrated circuit including the backplane 520, the active display area 530, bonding pads 640, and a control circuit for controlling the active display area 530. The control circuit may include a gate driver 635. The DDIC 510 may include a timing controller 610, a data processing circuit 615, an input/output (I/O) interface 625, a mobile industry processor interface (MIPI) receiver 630, a source driver circuit 645 and signal lines 624. In other embodiments, one or more components of the DDIC 510 may be disposed in the display element 540.

The timing controller 610 may be configured to generate timing control signals for the gate driver 635, the source driver circuit 645, and other components in the display element 540. The timing control signals may include one or more clock signals, a vertical synchronization signal, a horizontal synchronization signal, and a start pulse. However, timing control signals provided from the timing controller 610 according to embodiments of the present disclosure are not limited thereto.

The data processing circuit 615 may be configured to receive image data DATA from the MIPI receiver 630 and convert the data format of the image data DATA to generate data signals input to the source driver circuit 645 for displaying images in the active display area 530.

The I/O interface 625 is a circuit that receives control signals from other sources and sends operation signals to the timing controller 610. The control signals may include a reset signal RST to reset the display element 540 and signals according to serial peripheral interface (SPI) or inter-integrated circuit (I2C) protocols for digital data transfer. Based on the received control signals, the I/O interface 625 may process commands from a system on a chip (SoC), a central processing unit (CPU), or other system control chip.

The MIPI receiver 630 may be a MIPI display serial interface (DSI), which may include a high-speed packet-based interface for delivering video data to the pixels in the active display area 530. The MIPI receiver 630 may receive image data DATA and clock signals CLK and provide timing control signals to the timing controller 610 and image data DATA to the data processing circuit 615.

The active display area 530 may include a plurality of pixels arranged into rows and columns with each pixel including a plurality of subpixels (e.g., a red subpixel, a green subpixel, a blue subpixel). Each subpixel may be connected to a gate line GL and a data line DL and driven to emit light according to a data signal received through the connected data line DL when the connected gate line GL provides a gate-on signal to the subpixel.

The backplane 520 may include conductive traces for electrically connecting the pixels in the active display area 530, the gate driver 635, the source driver circuit 645, and the bonding pads 640. The bonding pads 640 are conductive regions on the backplane 520 that are electrically coupled to the signal lines 624 of the DDIC 510 to receive timing control signals from the timing controller 610, and data signals from the source driver circuit 645. The bonding pads 640 are connected to the gate driver 635 and other circuit elements in the backplane 520. In the embodiment illustrated in FIG. 6, the DDIC 510 generates data signals and timing control signals and transmits the signals to the bonding pads 640 of the display element 540. However, in other embodiments, the timing controller 610, the source driver circuit 645 and/or the data processing circuit 615 may be in the display element 540 instead of the DDIC 510. When the timing controller 610 and/or the data processing circuit 615 are on the display element 540, there may be fewer bonding pads 640 since the data signals and timing control signals may be directly transmitted to the corresponding component without a bonding pad 640.

The gate driver 635 may be connected to a plurality of gate lines GL and provide gate-on signals to the plurality of gate lines GL at appropriate times. The gate driver 635 includes a plurality of stages, where each stage is connected to a gate line GL that outputs gate-on signals to a row of pixels.

The source driver circuit 645 may receive data signals from the data processing circuit 615 and provide the data signals to the active display area 530 via data lines DL. The source driver circuit 645 may include a plurality of source drivers, each source driver connected to a column of pixels via a data line DL.

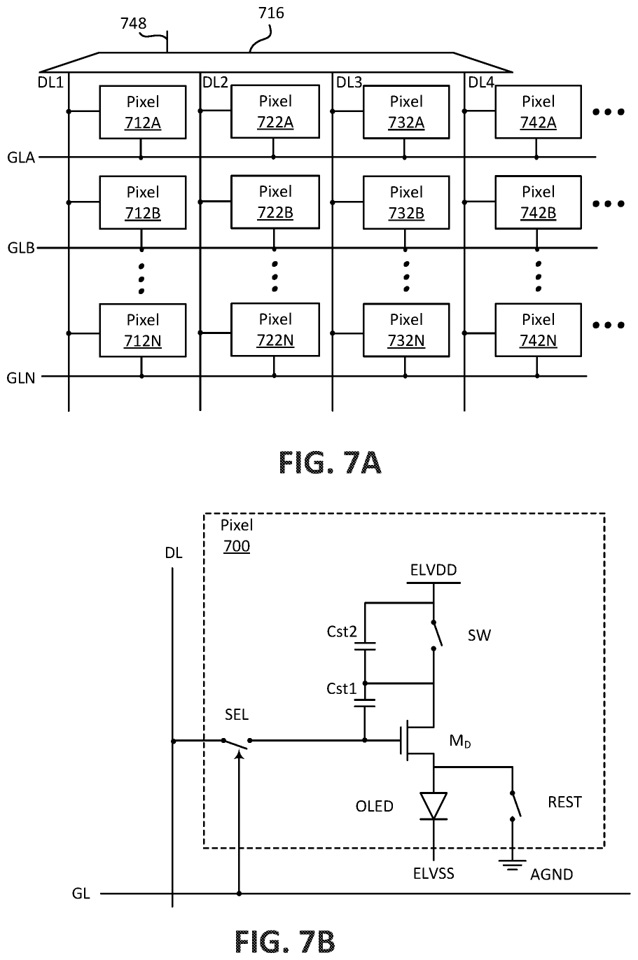

FIG. 7A illustrates an example pixel arrangement of a display device, according to some embodiments. The pixel arrangement includes, among others, columns of pixels 712A through 712N (collectively referred to also as “pixels 712” hereinafter), columns of pixels 722A through 722N (collectively referred to also as “pixels 722” hereinafter), columns of pixels 732A through 732N (collectively referred to also as “pixels 732” hereinafter), and columns of pixels 742A through 742N (collectively referred to also as “pixels 742” hereinafter). Although not illustrated in FIG. 7A, additional columns of pixels may be arranged at the right side and/or the left side of pixels columns shown. Each of pixels (e.g., pixel 712B) is connected to a corresponding data line (e.g., DL1) and a gate line (e.g., GLB). In other embodiments, each pixel 712, 722, 732, and 742 may correspond to another type of pixel, such as a micro-LED pixel, an LCD pixel, and/or the like.

Data lines (e.g., DL1 through DL4) are connected to a demultiplexer 716 that is connected to the source driver circuit 645 via the signal line 748 to receive multiplexed pixel data. Although only a single demultiplexer 716 is illustrated in FIG. 7A, other demultiplexers connected to different signal lines and other columns of pixels may be arranged at the right side and/or the left side of demultiplexer 716 to program additional columns of pixels. For example, in some embodiments, the display element comprises a plurality of demultiplexers, each connected to the source driver circuit 645 via a respective signal line and to a respective set of pixel columns via a respective set of data lines.

Pixel data V_{DATA} for programming columns of pixels is time multiplexed by a multiplexer (not shown) and then demultiplexed by demultiplexer 716 so that fewer signal lines (e.g., line 748) may be used between the source driver circuit 645 and the array of pixels. Because each demultiplexer receives pixel data V_{DATA} for programming pixels for its respective set columns of pixels in parallel, an amount of time needed to program all pixels for a particular row n of the display unit (referred to as a frame period T_{FRAME}) is defined by an amount of time to program the pixels of the row n corresponding to a particular demultiplexer. Although it is beneficial to multiplex the pixel data for more data lines using the multiplexer and the demultiplexer, the settling time associated with a reference voltage for compensating the threshold voltage of driving transistors in the pixels may restrict the extent of multiplexing/demultiplexing.

In some embodiments, each of the pixels 712, 722, 732, and 742 correspond to subpixels associated with a specific color channel. For example, in some embodiments as discussed above, each pixel of the display contains three subpixels corresponding to red, green, and blue color channels. In some embodiments, the pixels 712, 722, 732, and 742 connected to a common demultiplexer 716 correspond to subpixels of different color channels. For example, pixels 712, 722, and 732 may correspond to red, green, and blue subpixels, respectively, for a given column of pixels, while pixels 742 correspond to red subpixels for another column of pixels. In other embodiments, the pixels 712, 722, 732, and 742 connected to a common demultiplexer 716 correspond to subpixels of the same color channel. For example, the pixels 712, 722, 732, and 742 may correspond to red subpixels for different columns of pixels of the display.

The gate lines GLA through GLN provide gate-on signals to pixels from the gate driver 635. In the example of FIG. 7A, each row of pixels is connected one of the gate lines GLA through GLN to receive a gate-on signal. The gate-on signal indicates when a row of pixels should be connected to a data line to receive pixel data for programming the pixels, by controlling a data selection switch (SEL) of each pixel (e.g., as shown in FIG. 7B), where the SEL switch is turned on when the gate-on signal is active but is turned off when the gate-on signal is inactive.

The display element 540 further includes timing signal lines (not shown) from the gate driver 635 to provide other timing signals. For example, the display element 540 may include horizontal lines carrying timing signals for operating various switches in the pixels, as described below with reference to FIG. 7B.

FIG. 7B is a circuit diagram of a pixel 700, according to some embodiments. The pixel 700 may be any of the pixels in the display element 540 including, but not limited to pixels 712, 722, 732, or 724. While FIG. 7B illustrates the pixel 700 as an OLED pixel, it is understood that in other embodiments, the pixels of the display element 540 may be implemented as other types of pixels (e.g., LED pixels, LCD pixels, etc.) The pixel 700 may include, among other components, switch SEL, a driving transistor MD, an OLED, switch REST, switch SW, capacitor Cst1 and capacitor Cst2. The OLED is connected between a low voltage source ELVSS and a drain of the driving transistor MD. When switch SW is turned on and switch REST is turned off, the driving transistor MD generates current in its drain that increases as a voltage stored by the storage capacitor Cst1 increases. The current is then provided to the OLED to drive the OLED. The OLED then generates light of intensity that corresponds to the amount of current provided by the driving transistor MD.

The switch SEL controls a connection between the gate terminal of the driving transistor MD and the data line DL. When the gate line GL provides a gate-on signal (e.g., turns low), the switch SEL turns on, connecting the gate of the driving transistor MD to the data line DL and charging the storage capacitor Cst1 based on a voltage difference between the voltage of the pixel data at the data line DL and the high voltage level (ELVDD). When the gate-on signal is turned off in gate line GL, the switch SEL is turned off, disconnecting the gate of the driving transistor MD from the data line DL.

The switch REST enables or disables the current from the driving transistor MD to flow in the OLED. When the switch REST is turned on, current from the driving transistor MD flows through the switch REST to ground (AGND), bypassing the OLED. Conversely, when the switch REST is turned off, the current from the driving transistor MD flows in the OLED.

The switch SW is turned on or off to couple a high voltage source ELVDD to a source of the driving transistor MD. Capacitor Cst2 stores a voltage difference between the high voltage source ELVDD and the source of the driving transistor MD when the switch SW is turned off.

In some embodiments, driving transistor MD, the selection switch (SEL), reset switch (RES), and emission switch (SW) are each implemented as P-channel metal-oxide-semiconductor (PMOS) transistors, where gate signals of the selection switch (SEL), reset switch (RES), and emission switch (SW) are controlled by the timing signals provided via the gate driver circuitry of the display. In other embodiments, one or more of these components may be implemented using other types of switches (e.g., an NMOS transistor).

In some embodiments, data is written to each row of pixels of a display panel (e.g., display element 540) of a display device sequentially. For example, in some embodiments, the gate driver 635 includes a pulsing or shifting gate signal (also referred to herein as an “enable pulse”) that is provided sequentially to the plurality of stages corresponding to the rows of the display panel (e.g., along a series of shift registers). The enable pulse may serve as the gate-on signal provided along the gate line connecting a row of pixels, and each row of the display panel is programmed during a time period T_{Row} during which the enable pulse is provided to the gate line GL for the row (referred to as a “gate-on time” or a “row period”). The frame rate of the display is based on a row period T_{Row} for programming each row of the display panel. In addition, as discussed above, the pixels of each row are grouped based on one or more demultiplexers, where the row period T_{Row} may be based on an amount of time to program the pixels of the row corresponding a particular demultiplexer.

In some embodiments, a display device is configured to group the programming of pixels of multiple rows and/or multiple columns, where the same data value is provided to each pixel of the multiple rows and/or multiple columns simultaneously, resulting in a “virtual pixel” made up of multiple native pixels (also referred to as a “macropixel”). For example, the display device may group native pixels within m columns by n rows, where each pixel of the m columns and n rows is driven simultaneously to create an m×n macropixel. As used herein, columns may refer to pixels arranged in a direction parallel to the data lines of the display, while rows may refer to pixels arranged in a direction parallel to the gate lines of the display.

In some embodiments, grouping of native pixels into macropixels is performed to reduce an overall effective resolution of the display panel. For example, by grouping 2×2 sets of native pixels into macropixels, the effective resolution of the display is reduced by a factor of 4. In other embodiments, grouping of pixels into macropixels is performed as part of implementing a foveated display, where different regions of the display panel are configured to display image data at different resolutions. For example, in some embodiments, the display device is configured to display image data within a first display region at a native resolution, and image data within one or more additional display regions at lower resolutions, based upon the size of the macropixels within each region. In some embodiments, the locations of the display regions of a foveated display panel are configured dynamically based upon a gaze direction of the user, e.g., where a region of display around the gaze direction of the user (e.g., centered on a location of the display corresponding to the user's gaze) is configured to display image data at a native resolution, whereas other regions of the display are configured to display image data at lower resolutions.

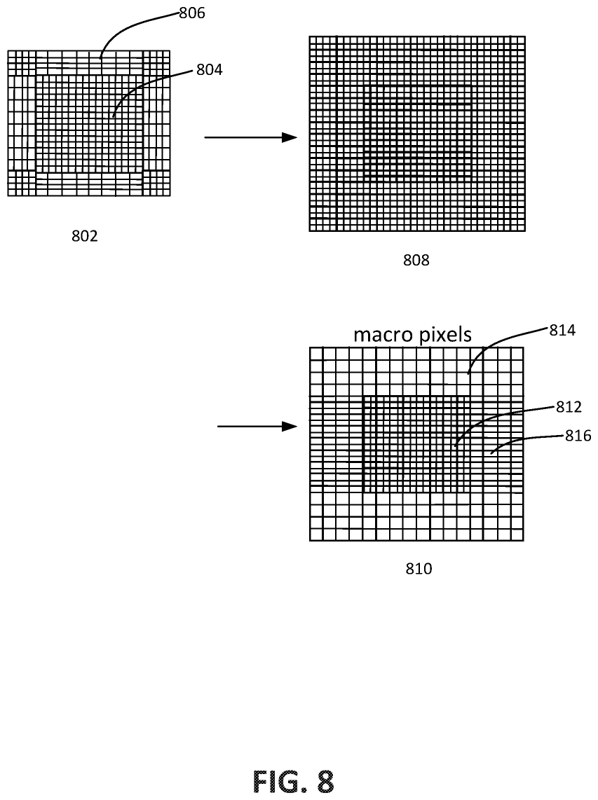

FIG. 8 illustrates a high level diagram showing implementation of a foveated display, in accordance with some embodiments. In some embodiments, the display device receives input image data 802 to be displayed on the display panel, where the input image data 802 comprises first image data 804 at a first resolution (e.g., a native resolution of the display device) and second image data 806 at a second lower resolution. In embodiments where macropixel grouping is not used, the image data is upscaled (e.g., by mapping each pixel of the second image data 806 to a plurality of native pixels of the display) to generate the displayed image data 808, which is displayed entirely in the native resolution of the display device. On the other hand, in embodiments where macropixel grouping is used, the display image data 810 is displayed in a first region 812 using the native pixels of the display device, and in a second region 814 using macropixels comprising groups of native pixels programed concurrently using the same data. In some embodiments, different regions of the display may be associated with different macropixel grouping sizes. For example, the display image data 810 may further include a third region 816 comprising macropixels of a different size compared to those of the second region 814.

In some embodiments, an m×n macropixel may correspond to a grouping of m columns and n rows of the display, such that all pixels in the intersection of the m columns and n rows are programmed with the same image data simultaneously, as if they were a single pixel. In some embodiments, the m columns of the display are grouped using grouped demultiplexing (GDX), in which a demultiplexer used to provide data from a signal line of the source driver circuit is configured to multiple data lines concurrently, resulting in each data line being loaded with the same image data. The n rows of the display are grouped using grouped gate scanning (GGS), discussed in greater detail below, in which the gate lines of multiple rows are grouped together, such that data from the data lines of the display is written to the pixels of each of the grouped rows concurrently, resulting in each of the grouped rows receiving the same image data. By grouping different sets of rows and columns at different portions of the display, different display regions having different effective resolutions (e.g., different sized macropixels) can be created. In some embodiments, by grouping native pixels into macropixels, power consumption of the display device may be reduced. In other embodiments, macropixel grouping may be used to increase a refresh rate of the display.

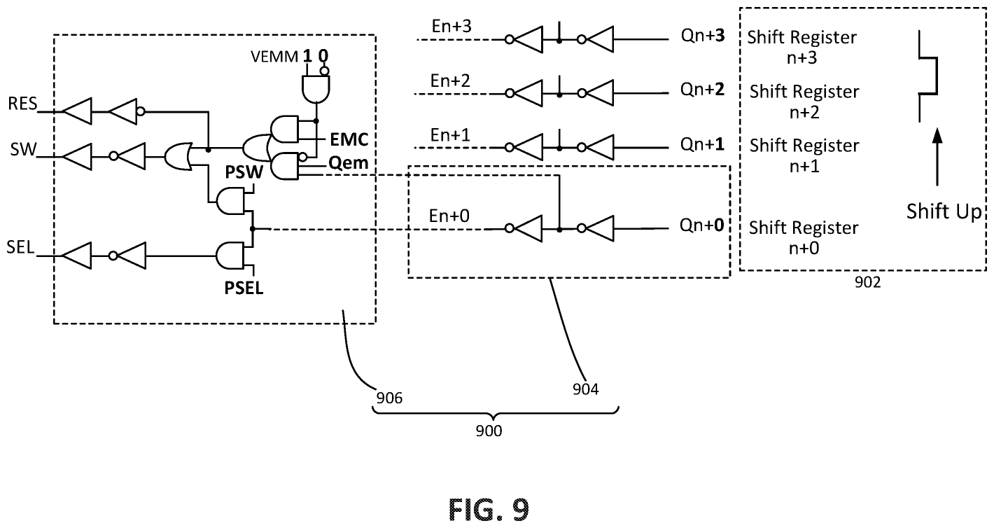

FIG. 9 illustrates a diagram of a gate scan driver for a row of the display panel, in accordance with some embodiments. In some embodiments, the gate scan driver 900 may be implemented as part of the gate driver circuitry 635 shown in FIG. 6. The gate scan driver 900 is coupled to a gate scan line 902 configured to sequentially provide an enable pulse to rows of the display device, wherein the rate at which the enable pulse is shifted between the rows of the display defines the row period T_{row} for programming each row of the display panel. In some embodiments, the gate scan line 902 comprises a plurality of shift registers (e.g., shift registers n+0, n+1, etc.) configured to pass the enable pulse from each row to the next row with a predetermined timing (e.g., in accordance with a clock as determined by the DDIC). The gate scan driver includes an scan enable circuit 906 configured to the receive the enable pulse (e.g., Qn+0, Qn+1, etc.) from the gate scan line 902 via an enable select circuit 904. In displays that do not implement grouped gate scanning, the enable select circuit 904 may simply pass the enable pulse (e.g., Qn+0) through to the scan enable circuit (e.g., via a pair of inverters) as an enable signal (e.g., En+0). The scan enable circuit 906 uses the received enable signal, in conjunction with additional signals received from the DDIC (e.g., PSEL, PSW, EMC, Qem, VEMM, etc.) to provide the SEL, SW, and RES signals for controlling the pixels of the row. For example, the DDIC provides a selection pulse, e.g., the PSEL pulse, to the rows of the display, defining a time during which data is written to pixels of the display. When a specific row concurrently receives an enable signal (e.g., based on the enable pulse provided by the gate scan line 902 and the enable select circuit 904), the SEL switches of pixels of the row are turned on, enabling programming of the pixels of the row.

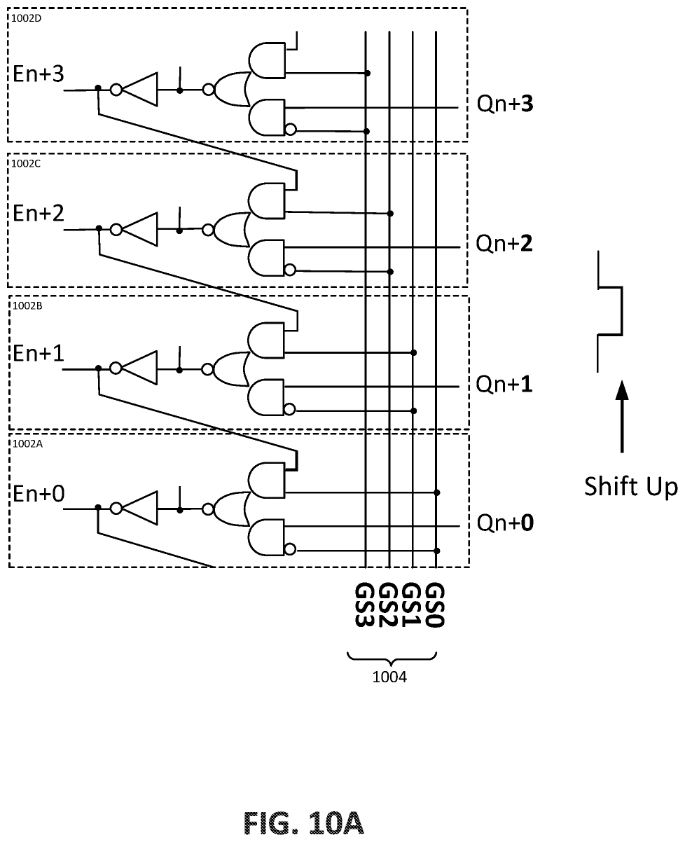

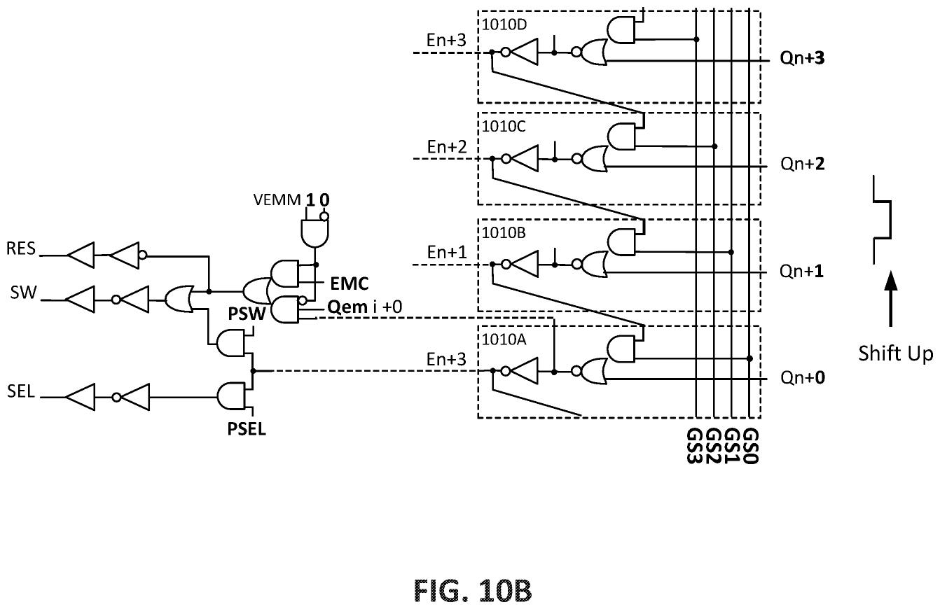

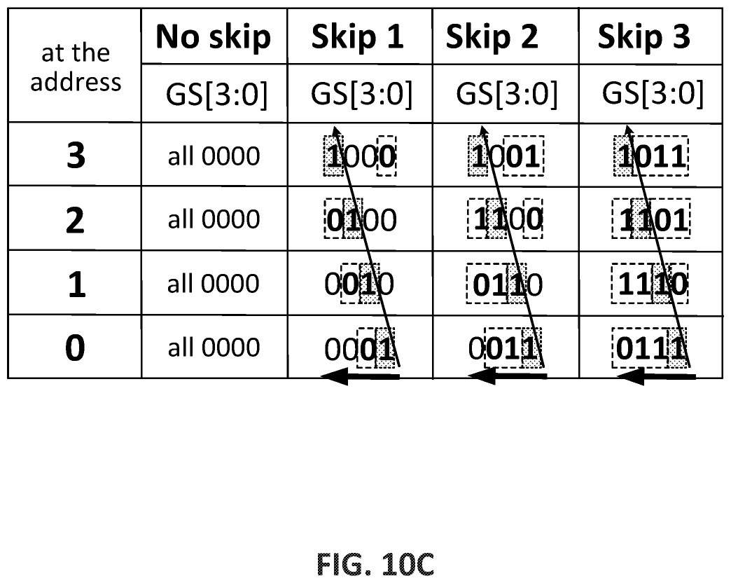

In some embodiments, grouped gate scanning is used to group rows of pixels such that the pixels of the grouped rows are programmed during the same row period, causing corresponding pixels of each of the grouped rows connected to the same data line to receive the same pixel value. FIGS. 10A and 10B illustrate diagrams of portions of gate scan drivers for a set of rows of the display panel that enable grouped gate scanning, in accordance with some embodiments. As shown in FIGS. 10A and 10B, the enable select circuit 1002 or 1010 of the gate scan driver contains logic circuitry that allow for the enable select circuit to pass to the scan enable circuit either the enable pulse from the gate scan line (e.g., Qn+0), or a gate enable signal from an adjacent row of the display (e.g., En+1). The logic circuitry of the enable select circuit 1002/1010 is coupled to one or more gate control lines 1004 of the plurality of gate control lines. In some embodiments, the rows of the display are divided into sets of N rows, where the enable select circuit of each row of a set is coupled to a different gate control line of the plurality of gate control lines, allowing for groupings of up to N rows. For example, FIGS. 10A and 10B show embodiments where there are four gate control lines (GS0, GS1, GS2, and GS3), and the rows of displays are divided into sets of four rows each, where each row is coupled to a different gate control line of the four gate control lines. This allows for rows of the display to be grouped into groups of up to 4 rows, which may be referred to as rows 0, 1, 2, and 3 corresponding to the rows shown in FIGS. 10A and 10B that receive the enable pulse Qn+0, Qn+1, Qn+2, and Qn+3.

FIG. 10A illustrates a full multiplexer implementation of the enable select circuit for a set for rows, in accordance with some embodiments. As shown in FIG. 10A, the enable select circuit 1002 for each row includes logic circuitry configured to, based upon a value provided via the gate control line for the row, select between the enable pulse provided by the gate scan line and the gate enable signal of the gate line of the adjacent row (e.g., an above row). For example, the enable select circuit 1002A is configured to provide the enable signal En+0 to the gate line of row 0 based on the signal of the GS0 gate control line. If GS0 is 0, the enable select circuit 1002A provides the enable pulse Qn+0 as the enable signal En+0. On the other hand, when GS0 is 1, the enable select circuit 1002A provides the enable signal En+1 output by the enable select circuit 1002B corresponding to row 1 as the enable signal En+0, instead of the enable pulse Qn+0, effectively grouping row 0 with row 1. Thus, the enable signal En+0 is provided to the gate line of row 0 by the enable select circuit 1002A not when the pulsing gate signal reaches the row (e.g., providing enable pulse Qn+0), but when the pulsing gate signal reaches an uppermost row that row 0 is grouped with. As such, the gate lines of all rows in the grouping of rows are enabled concurrently, causing the same data to be written to the pixels of each row. Control signals for the gate control lines GS0 through GS3 that may be used to group rows of the display in different configurations are discussed in greater detail in relation to FIG. 10C below.

FIG. 10B illustrates a half multiplexer implementation of the enable select circuit for a set for rows, in accordance with some embodiments. As shown in FIG. 10B, the enable select circuit 1010 for each row includes logic circuitry configured to pass through the enable pulse provided by the gate scan line, or, when a respective gate control line is enabled, pass through the gate enable signal of the gate line of an adjacent row. For example, the enable select circuit 1010A provides the enable pulse Qn+0 as enable signal En+0 to the gate line of row 0 (regardless of the whether the gate control line GS0 has been enabled), or, when the gate control line GS0 is enabled, the value of the enable signal En+1 of the above row as the enable signal En+0. In other words, when the gate control line GS0 is enabled, the enable select circuit 1010A sets the enable signal En+0 as high when the enable pulse Qn+0 is received, as well as when the enable signal of the above row En+1 is high. In some embodiments, the DDIC configures the timing of the PSEL and PSW signals for the row, so that the SEL and SW signals are provided to the pixels of the row when the pulsing gate signal reaches a last (e.g., an uppermost) row that the row is grouped with, so that the gate lines of all rows in the grouping of rows are enabled concurrently and for the same data to be written to the pixels of each row. For example, in an embodiment where row 0 is grouped with row 1, the DDIC does not provide a selection pulse (e.g., PSEL pulse) during the enable pulse Qn+0, but instead during the enable pulse Qn+1 (corresponding to row 1, the last row of the grouping), during which both row 0 and row 1 are enabled.

FIG. 10C illustrates a table showing control signal configurations for the gate control lines GS0 through GS3 that may be used to enable different groupings of rows using the gate enable circuits shown in FIGS. 10A and/or 10B, in accordance with some embodiments. As discussed above, four gate control lines (GS0, GS1, GS2, and GS3) may be used in embodiments where rows of displays are divided into sets of four rows each (e.g., modulus 4). The control signals provided to the gate control lines may be referred to as a gate scanning signal, being used for grouped gate scanning, or a scanning code. The table of FIG. 10C illustrates scanning codes corresponding to the gate control signals for the gate control lines GS[3:0].

As used in the table shown in FIG. 10C, “skip” refers to when data writing for a row is skipped when the enable pulse for the row are received, but occurs as part of a grouping with other rows. In other words, “No skip” refers to a configuration where no rows are grouped, “Skip 1” refers a grouping of two rows, “Skip 2” refers to a grouping of three rows, and “Skip 3” refers to a grouping of four rows. As used in the table of FIG. 10C, “at the address” refers to a row of a grouping of rows reached first by the enable pulse (e.g., a lowermost row where the enable pulse shifts upwards). For example, skip 2 at the address of 1 indicates a grouping of three rows containing rows 1, 2, and 3 of a set of rows, with row 1 of the set of rows being the first (e.g., lowermost) row of the group. Along the same lines, skip 1 at the address of 3 refers to a grouping of two rows, where row 3 of a set of rows is lowermost row of the grouping (i.e., is grouped with row 0 of a next set of rows).

As shown in table of FIG. 10C, when no row grouping is performed, the signals for the gate control lines GS0 through GS3 are all set to 0 (e.g., “0000”). Consequently, the enable select circuit for each row passes through the enable pulse (e.g., Qn+0, Qn+1, Qn+2, or Qn+3) when it is received, and thus not pass through the enable signal of an adjacent row. On the other hand, when row grouping is performed, the scanning code indicates a set of one or more sequential gate control lines that are enabled (e.g., set to 1), preceded by a gate control line that is disabled (e.g., set to 0, and may be referred to as the “leading 0”). The number of gate control lines GS0 through GS3 that are enabled (e.g., set to 1) corresponds to a skip count (e.g., based on a number of rows to be grouped), e.g., “01” corresponds to a grouping of 2 rows (GS2 or “Skip 1”), “011” corresponds to a grouping of 3 rows (GS3 or “Skip 2”), and “0111” corresponds to a grouping of four rows (GS4 or “Skip 3”). The position of the sequential 1s and preceding 0 (shown in FIG. 10C within dashed boxes) indicate which rows of a set of rows are grouped, where the address (e.g., row number) of a first row to be skipped (e.g., lowest row) corresponds to a location of an ending “1” (shown in FIG. 10C as within a shaded box), and the address of the last row of the group (e.g., the row that has its enable signal propagated to the remaining rows of the group) corresponding to the location of the leading 0. For example, the scanning code 1000 indicates a grouping of two rows, where a topmost row of a set of rows (e.g., row 3) is grouped with a first row (e.g., row 0) of a next set of rows.

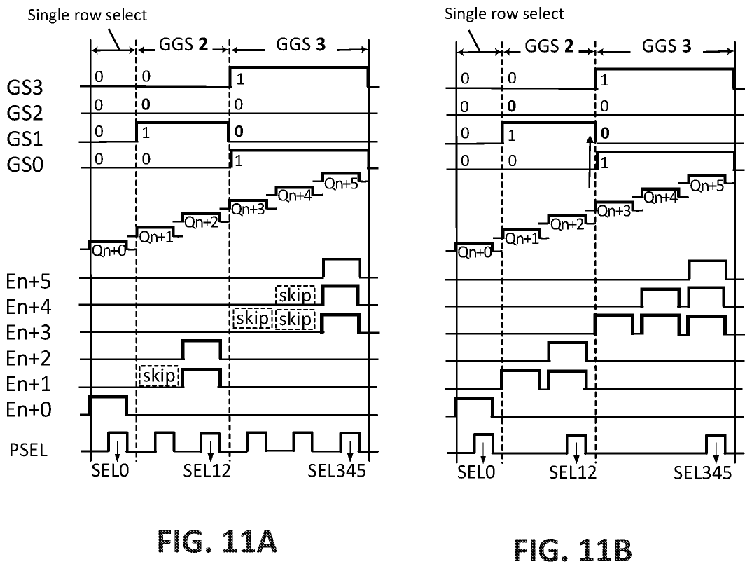

FIGS. 11A and 11B illustrate example timing diagrams showing control signals used for grouping different combinations of rows of a display, in accordance with some embodiments. FIG. 11A illustrates a timing diagram for an embodiment using a full multiplexor enable select circuit, such as that shown in FIG. 10A, while FIG. 11B illustrates a timing diagram for an embodiment using a half multiplexor enable select circuit such as that shown in FIG. 10B, in accordance with some embodiments. Similar to that illustrated in FIGS. 10A and 10B, the embodiments illustrated in FIGS. 11A and 11B utilize four gate control lines GS0 to GS3, where the rows of the display are grouped into sets of four. For example, in the examples illustrated in FIGS. 11A and 11B, rows 0, 1, 2, and 3 correspond to a first set of rows, while rows 4 and 5 are rows of a next set of rows (e.g., corresponding to rows 0 and 1 for the next set of rows).

By changing the scanning codes for the gate control lines GS0 through GS3 over time as the enable pulse is shifted along the rows of the display, different combinations of rows can be grouped together. For example, FIGS. 11A and 11B each illustrate timing diagrams in which row 0 of a set of rows is ungrouped, followed by rows 1 and 2 being grouped together, followed by row 3 of the set of rows being grouped with rows 0 and 1 of a next set of rows (i.e., rows 4 and 5). When the enable pulse is provided to row 0 (Qn+0), the scanning code sets each of the gate control lines GS0 to GS3 to 0, so that the enable control circuit for row 0 passes the pulse Qn+0 as the enable signal En+0 to its respective scan enable circuit. In addition, the DDIC provides a PSEL signal (labelled in FIG. 11A as SEL0, as it enables data writing for row 0 of the display), which together with the enable signal En+0, causes the gate line of the row to be turned on, enabling the writing of data to the pixels of the row.

When the enable pulse is provided to the next two rows (Qn+1 and Qn+2 corresponding to rows 1 and 2), the scanning code for the gate control lines (e.g., 0010) is set to group the two rows. In the embodiment illustrated in FIG. 11A, corresponding to the full-multiplexor embodiment shown in FIG. 10A, the enable select circuit for row 1 skips the enable pulse Qn+1 being provided as enable signal En+1 to the gate line of row 1, but instead provides the value of the enable signal En+2 of row 2 as the enable signal En+1 for row 1. On the other hand, the enable select circuit for row 2 is configured to provide the enable pulse Qn+2 as the enable signal En+2, which is also propagated to row 1 as En+1. Because it is “skipped,” no data is written to row 1 when the pulse enable signal Qn+1 is provided to row 1 even when the DDIC provides a PSEL pulse. Instead, data is written to the pixels of row 1 concurrently with those of row 2, when both En+1 and En+2 are enabled and the PSEL pulse is provided (labelled in FIG. 11A as SEL12, as it enables data writing for both rows 1 and 2). This results in the same data being written concurrently to the pixels of both rows (e.g., via the data lines of the display connected to the pixels of each row).

On the other hand, in the embodiment illustrated in FIG. 11B, corresponding to a half-multiplexor embodiment (e.g., as shown in FIG. 10B), the enable select circuit for row 1 passes through the enable pulse Qn+1 as the enable signal En+1, or the value of the enable signal En+2 of row 2 (e.g., when Qn+2 is provided by the enable pulse), as the enable signal En+1 for row 1. As such, the enable signal En+1 is provided during both the enable pulse Qn+1 and the enable pulse Qn+2. However, in this embodiment, the DDIC is configured to be provided the PSEL pulse non-periodically, based upon the grouping of rows. Because the PSEL signal provided by the DDIC is configured to be provided only when the enable pulse is being provided to a last row of the grouping (e.g., during Qn+2), no data is written to row 1 during the enable pulse Qn+1. Instead, data writing occurs for both row 1 and row 2 concurrently, when both En+1 and En+2 are provided, and the PSEL signal (e.g., SEL12) is provided.

Similarly, when the enable pulse is provided to the next three rows (Qn+3, Qn+4, Qn+5), the scanning code for the gate control lines (e.g., 1001) is set, as shown in the table of FIG. 10C, to correspond to a grouping of three rows (skip 2) starting at row 3. As shown in FIG. 11A, for the full-multiplexor embodiment, the enable select circuits for rows 3 and 4 each skip the enable pulses Qn+3 and Qn+4 being provided as enable signals En+3 and En+4 respectively, but instead provide the value of the enable signal En+5 of row 5. Consequently, rows 3, 4, and 5 (corresponding to En+3, En+4, and En+5) are enabled concurrently when the enable pulse Qn+5 is provided to row 5, resulting in the same data being written to the pixels of all three rows concurrently. On the other hand, in the half-multiplexor embodiment illustrated in FIG. 11B, the enable select circuits for rows 3 and 4 pass through the respective enable pulses Qn+3 and Qn+4, or the value of the enable signal En+5 of row 5 (e.g., when Qn+5 is provided). Because the PSEL signal provided by the DDIC is configured to be provided only when the enable pulse is being provided to a last row of the grouping (e.g., during Qn+5), data writing occurs for all three rows concurrently, when the PSEL signal (e.g., SEL345) is provided.

As the enable pulse is provided to subsequent rows of the display, the scanning code provided to the gate control signals may change to enable grouping of different groups of rows. For example, in an embodiment where the display is configured to group pairs of rows (e.g., “skip 1,” grouping rows 0 and 1 and grouping rows 2 and 3 from each set of four rows), the scanning code may alternate between 0001 and 0100 based on a current row associated with the enable pulse. In an embodiment where the display is configured to group groups of three rows (“skip 2”), the scanning code changes based on the timing of the enable pulse to group different rows of each set of rows (e.g., for sets of four rows, using the code 0011 to group rows 0, 1, and 2 of a first set, code 1001 to group row 3 of the first set with rows 0 and 1 of a second set, code 1100 to group rows 2 and 3 of the second set with row 0 of a third set, etc.). For example, as shown in FIGS. 11A and 11B, the scanning code may change as the enable pulse is shifted to a row corresponding to a next grouping of rows, to account for a grouping that the row currently receiving the enable pulse is a part of.

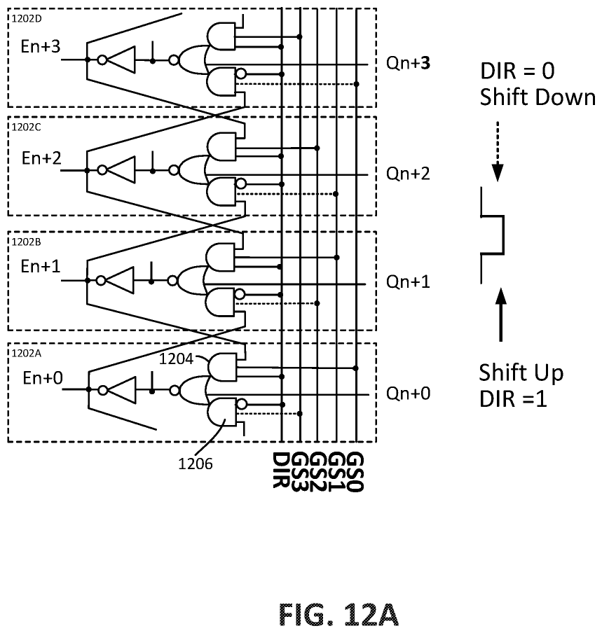

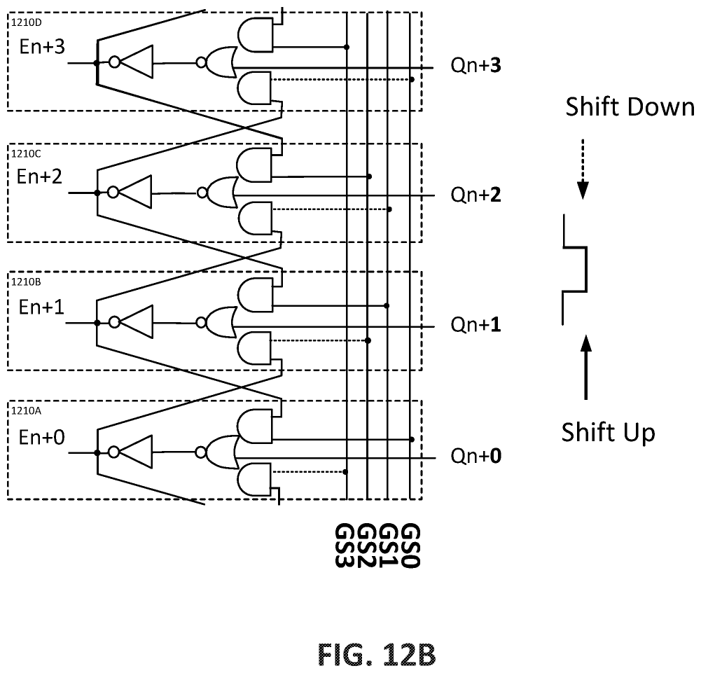

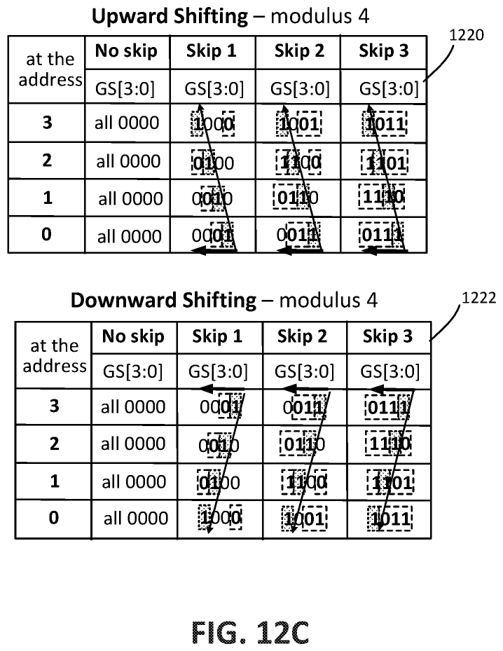

In some embodiments, such as those illustrated in FIGS. 10A and 10B, the pulse enable signal is configured to shift in one direction along the display (e.g., upwards). In other embodiments, the pulse enable signal may be configured to shift in either direction (e.g., upwards or downwards), and the enable select circuit for each row of the display is configured to allow for grouped gate scanning for either shifting direction. FIG. 12A illustrates a diagram of a bidirectional enable select circuit utilizing a directional signal line, in accordance with some embodiments. As shown in FIG. 12A, a directional signal line DIR is provided in addition to the gate control lines GS0 through GS3, and indicates a shifting direction of the enable pulse. For example, in some embodiments, DIR=0 indicates downward shifting, while DIR=1 indicates upward shifting.

As shown in FIG. 12A, each enable select circuit 1202 includes a first portion 1204 and a second portion 1206 each configured to selectively provide an enable signal of a next row of the display, based upon a shifting direction of the enable pulse. For example, the first portion 1204 is configured to provide the enable signal of a row in the upwards direction when DIR=1, and the second portion 1206 is configured to provide the enable signal of a row in the downwards direction with DIR=0. As only one of the first and second portions 1204 and 1206 is utilized at a given time (e.g., based on the value of DIR), the enable select circuits 1202 essentially function as half-multiplexor enable select circuits, similar to that illustrated in FIG. 10B.

FIG. 12B illustrates a diagram of a bidirectional enable select circuit without utilizing a directional signal line, in accordance with some embodiments. The enable select circuits 1210 of FIG. 12B are similar to the enable select circuits 1202 of FIG. 12A, except that they lack a connection to a directional signal line DIR. Due to a lack of a directional signal line DIR, both portions of the enable select circuit 1214 and 1216 are active and may pass through the enable signals of adjacent rows. However, the shifting direction of the enable pulse (either upwards or downwards) intrinsically the propagation of the enable pulse to the different rows via the enable select circuits 1210, eliminating a need for a separate DIR signal line.

FIG. 12C illustrates a table showing control signal configurations for the gate control lines GS[3:0] that may be used to enable different groupings of rows using the gate enable circuits shown in FIG. 12A or 12B, in accordance with some embodiments. Table 1220 illustrates scanning codes that may be used for different grouping of rows when the enable pulse is upward shifting, while table 1222 illustrates scanning codes that may be used for different grouping of rows when the enable pulse is downward shifting. As illustrated in FIGS. 12A and 12B, the first and second portions 1204/1214 and 1206/1216 of each enable select circuit 1202/1210 are connected to opposite sets of gate control lines, e.g., with the first portions 1204/1214 of the enable select circuits 1202/1210 of rows 0 through 3 connected to gate control lines GS0 through GS3, and the second portions 1206/1216 of the enable select circuits 1202/1210 of rows 0 through 3 connected to gate control lines GS3 through GS0. As the order of which the first or second portions of the enable select circuits are connected to the gate control lines aligns with the shifting direction, the same scanning codes can be used to group the rows of the display for either upward or downward shifting, e.g., “01,” “011,” and “0111” corresponding to a groupings of 2, 3, and 4 rows respectively. For example, similar to as discussed above in relation in FIG. 10C, the number of is of the scanning code indicates a skip count, where the address of first row to be skipped (e.g., highest or lowest row, depending on shift direction) corresponds to a location of an ending 1, and the address of the last row of the group (e.g., the row that has its enable signal propagated to the remaining rows of the group) corresponding to the location of the leading 0. For example, the scanning code 1000, for upwards shifting, indicates a grouping of two rows, where a topmost row of a set of rows (e.g., row 3) is grouped with a first bottommost row (e.g., row 0) of a next set of rows. The same code, for downwards shifting, indicates a grouping of two rows, where bottommost row of a set of rows (e.g., row 0) is grouped with a topmost row (e.g., row 3) of a next set of rows.

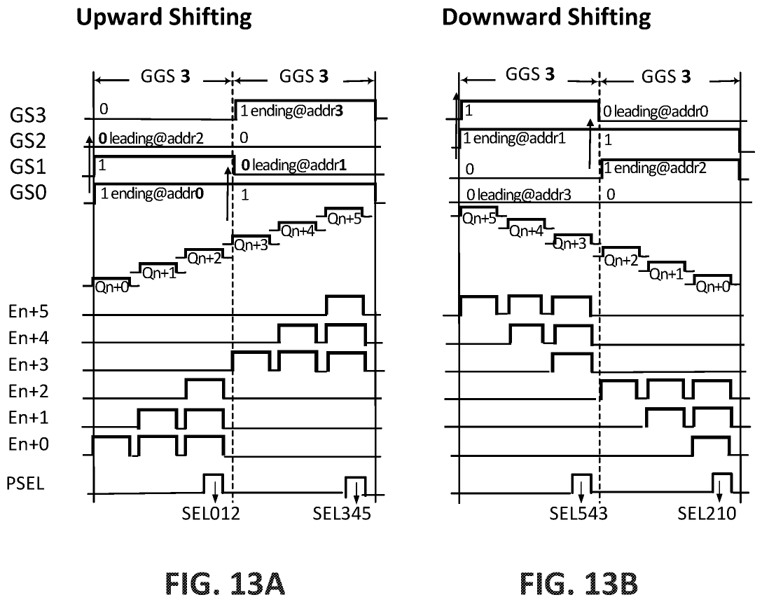

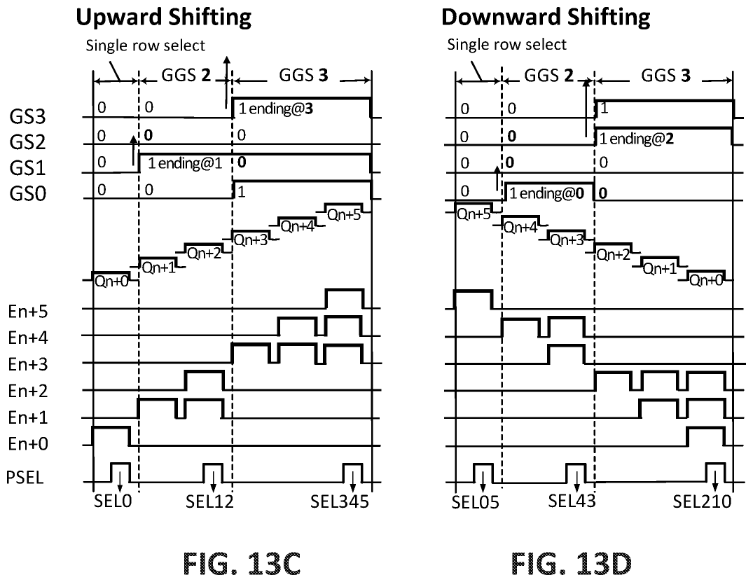

FIGS. 13A-13D illustrate example timing diagrams showing control signals for grouping different combinations of rows of a display, in accordance with some embodiments. FIGS. 13A and 13B illustrate timing diagrams showing six rows grouped into groupings of three rows each, e.g., grouping rows 0, 1, and 2 of a first set of rows, and grouping row 3 with rows 4 and 5 (corresponding to rows 0 and 1 of a next set of rows). FIG. 13A illustrates an embodiment where the enable pulse is configured to shift upwards, e.g., from Qn+0 to Qn+5. As shown in FIG. 13A, the gate control lines GS[3:0] are set using the scanning code 0011 to group rows 0, 1, and 2 during a first time period during which the enable pulse is provided to these rows, such that data is written to the pixel of all three rows concurrently when PSEL is enabled. The gate control lines GS[3:0] are then set using the scanning code 1001 during a second time period to group rows 3, 4, and 5, such that data is written to the pixel of all three rows concurrently when PSEL is enabled.

FIG. 13B illustrates an embodiment where the enable pulse is configured to shift downwards, e.g., from Qn+5 to Qn+0. As shown in FIG. 13B, the gate control lines GS[3:0] are set using the scanning code 1100 to group rows 5, 4, and 3 during a first time period during which the enable pulse is provided to these rows, such that data is written to the pixel of all three rows concurrently when PSEL is enabled. The gate control lines GS[3:0] are then set using the scanning code 0110 during a second time period to group rows 2, 1, and 0, such that data is written to the pixel of all three rows concurrently when PSEL is enabled.

FIGS. 13C and 13D illustrate timing diagrams showing different groupings of rows, including a first ungrouped row, a grouping of two rows, followed by a grouping of three rows, in accordance with some embodiments. FIG. 13C illustrates an embodiment where the enable pulse is configured to shift upwards, and where row 0 of a first set of rows is ungrouped, rows 1 and 2 are grouped, and row 3 is grouped with rows 4 and 5 (corresponding to rows 0 and 1 of a subsequent set of rows). The signals used to perform this grouping are similar to those illustrated in FIG. 11B, which show the same grouping of rows for an upward shifting enable pulse.

FIG. 13D illustrates an embodiment where the enable pulse is configured to shift downwards, and where row 5 is ungrouped, rows 4 and 3 are grouped as a group of two rows, and rows 2, 1, and 0 are grouped as a group of three rows. As shown in FIG. 13D, the scanning code for the gate control lines G[3:0] changes as the enable pulse travels between each group of rows, and data is written concurrently to the pixels of all rows within a group during a period in which the enable pulse is provided to a last row of the group (e.g., during Qn+5, Qn+3, and Qn+0).

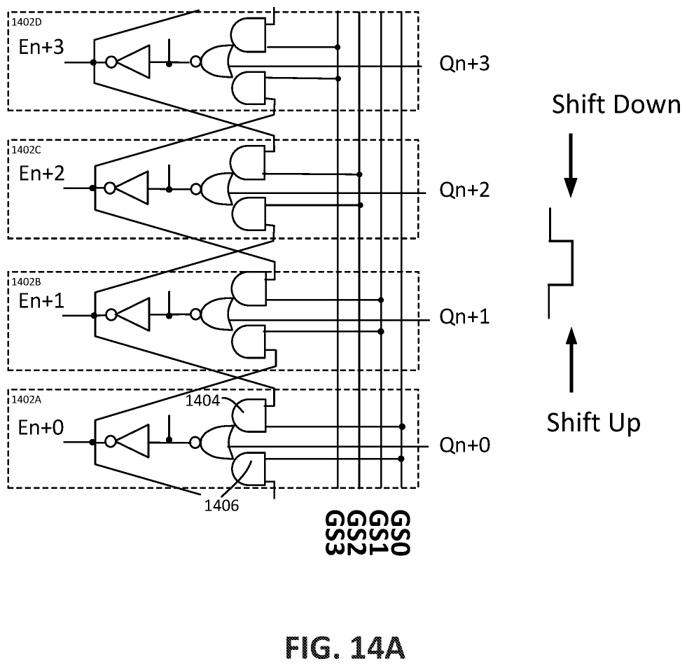

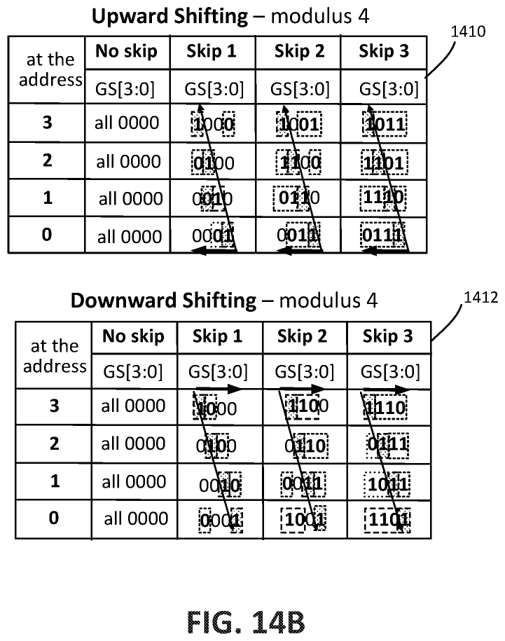

In some embodiments, the manner in which the enable select circuits of reach row of a set of rows is coupled to the gate control signals may be different than that described above in relation to FIGS. 12A and 12B. FIG. 14A illustrates another diagram of bidirectional enable select circuits for a set of rows, in accordance with some embodiments. Unlike the enable select circuits 1210 illustrated in FIG. 12B, the enable select circuits 1402 of FIG. 14A have first and second portions 1404 and 1406 connected to the same control line. For example, the first and second portions 1404 and 1406 of the enable select circuit 1402A for row 0 of the set of rows are both coupled to GS0, the first and second portions of the enable select circuit 1402B for row 1 of the set of rows are both coupled to GS1, etc. FIG. 14B illustrates a table showing control signal configurations for the gate control lines GS[3:0] that may be used to enable different groupings of rows using the gate enable circuits shown in FIG. 14A, in accordance with some embodiments. Because the first and second portions of each enable select circuit 1402 are coupled to the same control line, the scanning codes for GS[3:0], the skip code direction for is the opposite for upwards and downwards shifting. For example, while scanning codes for upward shifting include a set of one or more sequential gate control lines that are enabled (e.g., including an “ending 1”), preceded by a gate control line that is disabled (e.g., “leading 0”), scanning codes for downward shifting include a set of one or more sequential gate control lines that are enabled (e.g., including a “leading 1”), followed by a gate control line that is disabled (e.g., “ending 0”). In some embodiments, the DDIC includes two code generators, for generating scanning codes for upward shifting and for downward shifting, respectively.

As shown in Table 1410 of FIG. 14B, scanning codes for upward shifting are similar to those discussed in relation to FIG. 10C, where the address of first row to be skipped (e.g., lowest row of a group) corresponds to a location of an ending 1, and the address of the last row of the group (e.g., the topmost row that has its enable signal propagated to the remaining rows of the group) corresponding to the location of the leading 0. On the other hand, as shown in Table 1412, which shows example codes for downward shifting, the address of the first row to be skipped (e.g., highest row of a group) corresponds to a leading 1, and the address of the last row of the group (e.g., the lowest row that has its enable signal propagated to the remaining rows of the group) corresponds to an ending 0 of the scanning code. For example, the scanning code 1000, for upwards shifting, indicates that a grouping of two rows, where a topmost row of a set of rows (e.g., row 3) is grouped with a first row (e.g., row 0) of a next set of rows. The same code, for downwards shifting, indicates a grouping of two rows, where a topmost row of a set of rows (e.g., row 3) is grouped with the second topmost row (e.g., row 2) of the set of rows.

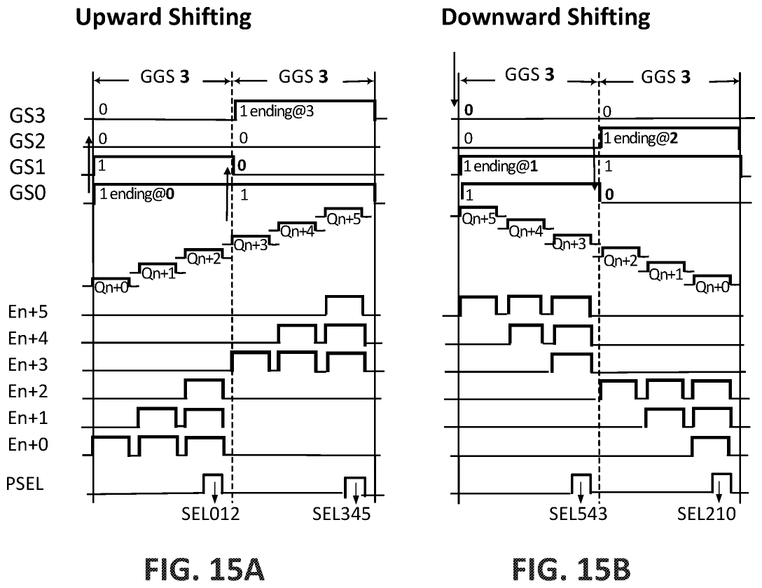

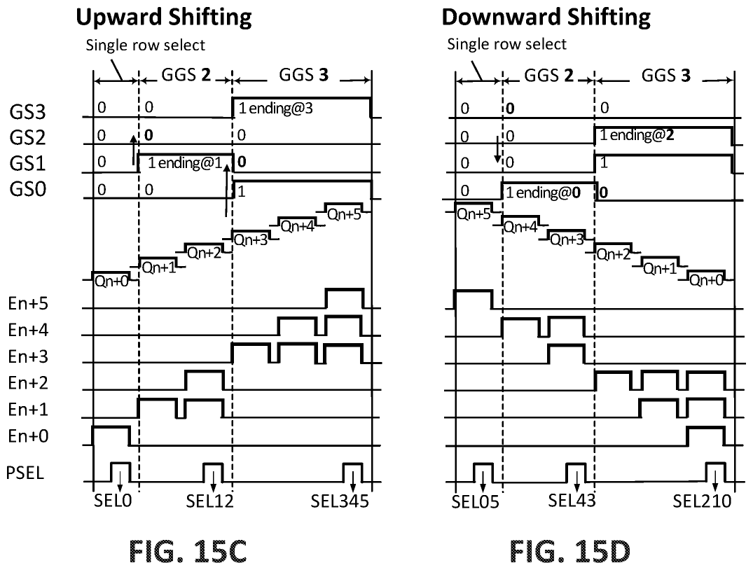

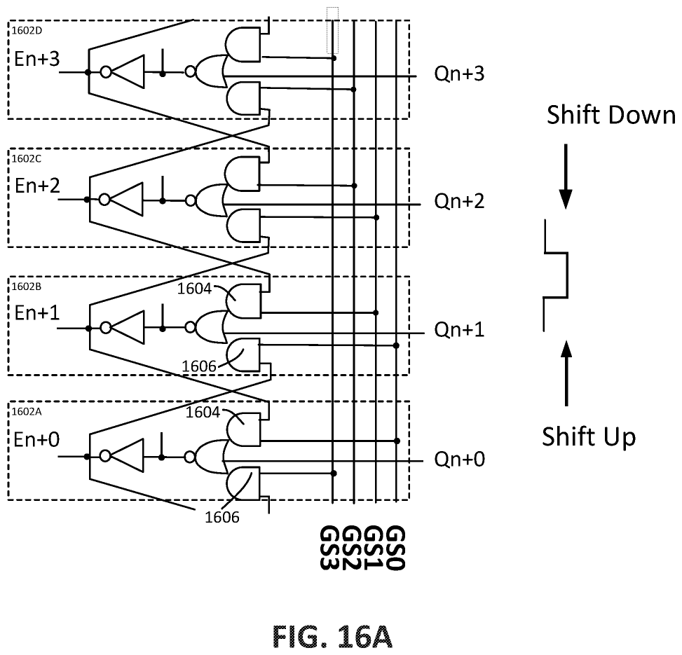

FIGS. 15A-15D illustrate example timing diagrams showing control signals for grouping different combinations of rows of a display, using the enable select circuits illustrated in FIG. 14A, in accordance with some embodiments. FIGS. 15A and 15B illustrate timing diagrams showing groupings of three rows each, e.g., grouping rows 0, 1, and 2 of a first set of rows, and grouping row 3 with rows 4 and 5 (corresponding to rows 0 and 1 of a next set of rows), where the enable pulse is configured to shift upwards and downwards respectively. FIGS. 15C and 15D illustrate timing diagrams showing different groupings of rows, including a first ungrouped row, a grouping of two rows, followed by a grouping of three rows, where the enable pulse is configured to shift upwards and downwards respectively, in accordance with some embodiments. As signals used for row grouping when the enable pulse is configured to shift upwards are the same for the enable select circuits shown in FIG. 14A as those of the enable select circuits shown in FIG. 12B, the signals shown in FIGS. 15A and 15C are identical to those shown in FIGS. 13A and 13C. FIGS. 15B and 15D, which correspond to embodiments where the enable pulse is configured to shift in a downwards direction, illustrate the scanning code for the gate control lines G[3:0] configured using the codes shown in Table 1412 of FIG. 14B, which change as the enable pulse travels between each group of rows, and data is written concurrently to the pixels of all rows within a group during a period in which the enable pulse is provided to a last row of the group.

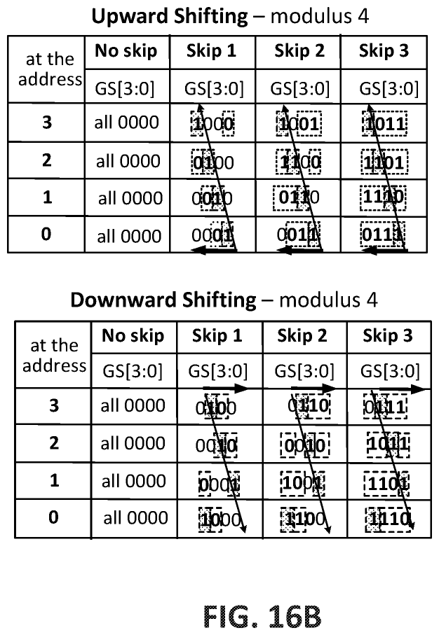

FIG. 16A illustrates another diagram of bidirectional enable select circuits for a set of rows, in accordance with some embodiments. In the embodiment illustrated in FIG. 16A, the first and second portions of each enable control circuit 1602 are coupled a pair of gate control lines that are offset by one. As such, the first portion of the enable select circuit 1604 for a first row is coupled to the same gate control line as the second portion of the enable select circuit 1606 for an adjacent row (e.g., the first portion of the enable select circuit of row 0 and the second portion of the enable select circuit of row 1 both being coupled to the GS0 gate control line). FIG. 16B illustrates a table showing control signal configurations for the gate control lines GS[3:0] that may be used to enable different groupings of rows using the gate enable circuits shown in FIG. 14A, in accordance with some embodiments. Because the first and second portions of each enable select circuit are coupled to gate control lines offset by one, the scanning codes for GS[3:0], the skip code direction for is the opposite for upwards and downwards shifting, as well as offset by one. For example, scanning codes for upward shifting are similar to those discussed in relation to FIG. 10C, where the address of first row to be skipped (e.g., lowest row of a group) corresponds to a location of an ending 1, and the address of the last row of the group (e.g., the row that has its enable signal propagated to the remaining rows of the group) corresponding to the location of the leading 0. On the other hand, for downward shifting, the address of the first row to be skipped (e.g., highest row of a group) corresponds to a leading 1 offset by one, and the address of the last row of the group (e.g., the lowest row that has its enable signal propagated to the remaining rows of the group) corresponds to an ending 0 of the scanning code offset by one. For example, the scanning code 1000, for upwards shifting, indicates that a grouping of two rows, where a topmost row of a set of rows (e.g., row 3) is grouped with a first row (e.g., row 0) of a next set of rows. The same code, for downwards shifting, indicates a grouping of two rows, where a bottommost row of a set of rows (e.g., row 0) is grouped with the topmost row (e.g., row 3) of a next set of rows.

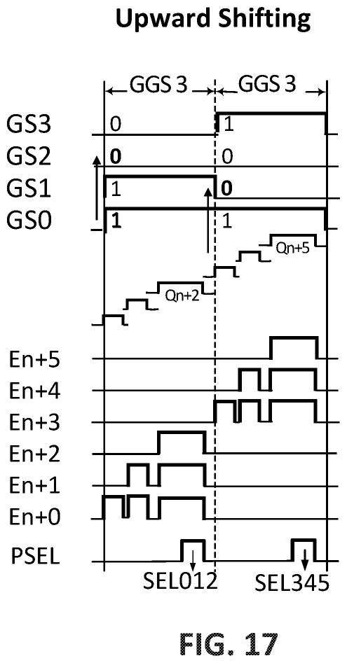

As discussed above, in some embodiments, when multiple rows of the display are grouped, data is written to the pixels of all of the grouped rows concurrently, e.g., during a time period in which the enable pulse is applied at a last row of the group, which propagates its enable signal to the remaining rows of the group through the enable select circuits of the rows. Consequently, no data is being written to the pixel of any rows of the display during time periods in which the enable pulse is applied at the remaining rows of the group that are not the last row, e.g., rows where the enable select circuit for the row is configured to provide the gate enable signal to an adjacent (e.g., next) row as the gate enable signal for the row. These time periods may be referred to as no-SEL periods, as no PSEL signal is provided during these periods. In some embodiments, the DDIC may dynamically configure the clock of the shift register, which controls the rate or shifting frequency at which the enable pulse shifts between the rows of the display, based on whether data writing is to occur during the enable pulse. FIG. 17 illustrates an example timing diagram with control signals for grouping rows of a display, in accordance with some embodiments. FIG. 17 illustrates groupings of three rows each, e.g., grouping rows 0, 1, and 2 of a first set of rows, and grouping row 3 with rows 4 and 5 (corresponding to rows 0 and 1 of a next set of rows), where enable pulse is configured to shift upwards, e.g., from Qn+0 to Qn+5, similar to that shown in FIGS. 13A and 15A. However, as shown in FIG. 17, because no data writing occurs during the no-SEL periods, the shift register clock speed is increased during each no-SEL period, shortening the shifting frequency of the enable pulse and reducing a duration of the enable pulse for those rows. This may be performed to reduce a total amount of time needed for the display to grouped rows of the display. In some embodiments, the shift register clock speed during both the no-SEL periods and the SEL period for the grouped rows may be increased, such that pixels of the grouped rows are programmed and displayed within the same row period duration needed to program and display a single, ungrouped row, as an amount of time to charge data lines prior to concurrent data writing for the grouped rows (as indicated by the provided PSEL signal) may be independent from the number of grouped rows, and may be performed over the multiple shortened no-SEL and SEL periods. In some embodiments, reducing a total amount of time needed for the display of grouped rows of the display is performed to increase a refresh rate of the display.

In other embodiments, by reducing an amount of time needed to display grouped rows, a larger resolution display may be used while preserving a desired refresh rate. For example, in embodiments where the display contains a first region with grouped rows and a second area with native resolution (e.g., no grouped rows), reducing a time needed to display grouped rows may allow for additional charging time to be allotted to areas of native resolution on the display. This may allow for the display area of the display to include a larger number of rows in the native resolution area of the display, and have each row be allotted sufficient charging time, without changing the overall refresh rate of the display.

In some embodiments, grouping rows of the display using grouped gate scanning is performed to reduce power consumption of the display. For example, by grouping rows of the display for concurrent data writing, an effective number of rows of the display is reduced, reducing a data line toggling frequency of the display, resulting in reduced power consumption. In addition, by increasing the shift register clock speed during no-SEL periods, time periods during which data writing occurs may be extended without reducing the refresh rate of the display. By extending data line charging time for charging the capacitors of each pixel circuit, a bias current for driving the data lines of the display may be reduced, further decreasing power consumption.

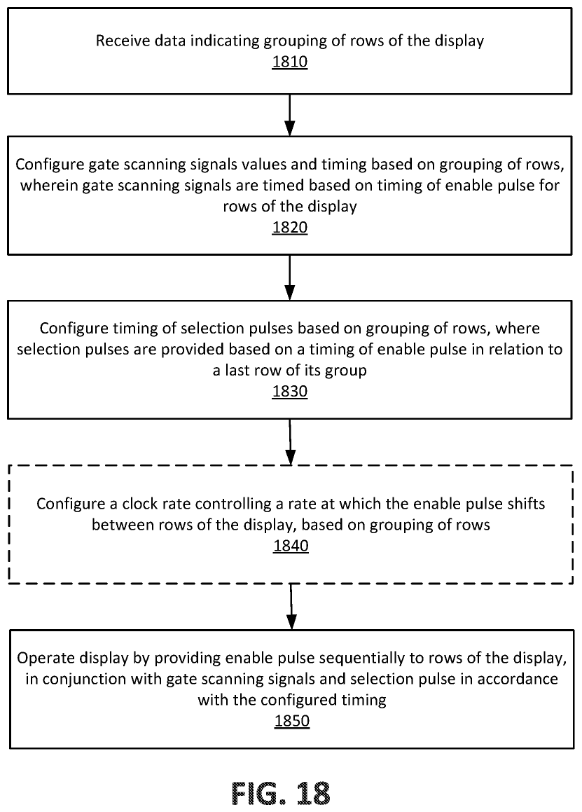

FIG. 18 is a flowchart illustrating a method of configuring a display to perform grouped gate scanning for a display device, according to some embodiments. In some embodiments, the method may be performed by a DDIC of a display device having gate scan driver circuits that include enable select circuits (such as those illustrated in FIGS. 10A, 10B, 12A, 12B, 14A, and 16A) coupled to each gate line of the display, where each enable select circuit is connected to one or more gate control lines of a set of gate control lines. In some embodiments, the rows of the display are grouped into sets of n (e.g., 4) rows each, based a number of gate control lines of the set of gate control lines.

The DDIC receives 1810 data indicating a grouping of rows of the display. In some embodiments, the data indicates one or more regions of the display, each configured to display image data at different resolutions by grouping native pixels of the display into macropixels, where macropixels of different regions are associated with different groupings of rows of the display. In some embodiments, the grouping of rows indicates a first region of the display area containing rows of pixels grouped at a first frequency (e.g., no grouping, or native resolution), and a second region of the display area containing rows of pixels grouped at a second frequency (e.g., groupings of pairs of rows for half resolution, groupings of three rows for one-third resolution, etc.). In embodiments where the rows of the display are grouped into sets of n (e.g., 4) rows each, based a number of gate control lines of the set of gate control lines, each macropixel may correspond to a grouping of up to n rows.

The DDIC configures 1820 gate signals values and timing to be provided to the gate control lines, based on the data indicating the grouping of rows, where the gate scanning signals are timed based on timing of an enable pulse that shifts between the rows of the display in a specified direction. For example, in some embodiments, a timing at which the gate scanning signals are used to set the gate control lines is synchronized with a timing of the enable pulse, such that during operation of the display, the gate scanning signals are configured to control a grouping of rows that includes a current row that is receiving the enable pulse.

The DDIC configures 1830 a timing of a selection pulse (e.g., PSEL pulse) that defines time periods during which pixel writing occurs on the display, based on timing of the enable pulse and the data indicating the grouping of rows. For example, in some embodiments, the DDIC is configured such that a selection pulse is provided based on a timing of an enable pulse provided to a last row of a grouping of rows, and is not provided during time periods in which the enable pulse is provided to rows of the display that are not the last row of a grouping of rows.

The DDIC optionally configures 1840 a clock rate controlling a rate at which the enable pulse shifts between rows of the display, based on the data indicating the grouping of rows. For example, in some embodiments, because data writing occurs when the enable pulse is provided to the last row of group of rows, the DDIC increases the clock rate for when the enable pulse is provided to rows that are not the last row of a grouping of rows. In some embodiments, by increasing the clock rate for such rows, the DDIC may decrease the clock rate for when the enable pulse is provided to the last row of the a grouping of rows, extending a charging time for data writing, without reducing an overall refresh rate of the device.

The DDIC operates 1850 the display by providing the enable pulse sequentially to the rows of the display in a specified direction in accordance with the clock rate, in conjunction with the gate scanning signals and selection pulse in accordance with the configured timing. As the enable pulse shifts between rows of the display in accordance with the clock, the gate scanning signals and the selection pulse are provided with a timing that causes rows of the display to be grouped together in accordance with on the data indicating the grouping of rows, in which data is written to the pixels of all rows of a given group concurrently during a time period in which the enable pulse is provided to a last row of the group, e.g., an uppermost row in embodiments where the enable pulse shifts upwards. As such, by grouping rows of the display in this manner, an effective number of rows of the display device is reduced, reducing a data line toggling frequency of the display, resulting in reduced power consumption.

The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the disclosure, which is set forth in the following claims.

What is claimed is:

1. A display device comprising:
a display area comprising a plurality of pixels arranged in a plurality of rows, each row comprising a respective gate line configured to provide a gate enable signal to pixels of the row; and
a plurality of gate scan driver circuits, each coupled to a gate line of a respective row of the plurality of rows, and to a gate scan line configured to sequentially provide an enable pulse to gate scan driver circuits of the plurality of gate scan driver circuits over a plurality of time periods, and configured to selectively provide the enable pulse provided by the gate scan line or a gate enable signal of a gate line of an adjacent row of the plurality of rows as a gate enable signal to the gate line of the respective row, based upon a predetermined grouping of rows of the display device.

2. The display device of claim 1, wherein:
each of the plurality of gate scan driver circuits is connected to one or more gate control lines of a plurality of gate control lines configured to provide a gate scanning signal based on the predetermined grouping of rows of the display device, and
wherein each gate scan driver circuit is each configured to selectively provide the enable pulse or the gate enable signal of the gate line of the adjacent row as the gate enable signal for the respective row based on the gate scanning signal.

3. The display device of claim 2, wherein the gate scanning signal is configured to change over time based upon a current row receiving the enable pulse from the gate scan line.

4. The display device of claim 2, wherein the plurality of gate control lines includes n gate control lines, and wherein the plurality of rows is divided into sets of n rows each, wherein each gate scan driver circuit of a set of n rows is connected to a respective gate control line of the n gate control lines.

5. The display device of claim 4, wherein the plurality of gate control lines includes 4 gate control lines.

6. The display device of claim 4, wherein the gate scanning signal indicates a number and a position of a group of rows of the predetermined grouping of rows within a set of n rows associated with a current position of the enable pulse.

7. The display device of claim 1, wherein each gate scan driver circuit comprises circuitry to select between the enable pulse provided by the gate scan line and the gate enable signal of the gate line of the adjacent row.

8. The display device of claim 1, wherein each gate scan driver circuit comprises circuitry configured to pass through the enable pulse provided by the gate scan line or the gate enable signal of the gate line of the adjacent row.

9. The display device of claim 1, wherein each gate scan driver circuit is further configured to receive a selection pulse defining a time period during which the gate enable signal is provided to the pixels of the respective row.

10. The display device of claim 9, wherein a selection pulse for a row of the plurality of rows is received concurrently with an enable pulse provided by the gate scan line at a last row of a group of rows containing the row, based upon the predetermined grouping of rows.

11. The display device of claim 1, wherein the gate scan line is configurable to sequentially provide the enable pulse to gate scan driver circuits of the plurality of gate scan driver circuits in a first direction or a second direction.

12. The display device of claim 11, wherein each gate scan driver circuit comprises first circuitry to receive a gate enable signal of a gate line of an adjacent row in the first direction, and second circuitry to receive a gate enable signal of a gate line of an adjacent row in the second direction.

13. The display device of claim 1, wherein the display device is configured to shorten a shifting frequency of the gate scan line when the enable pulse is provided to a row of the plurality of rows where the gate scan driver of the row is configured to provide a gate enable signal of an adjacent row as a gate enable signal for the row.

14. The display device of claim 1, wherein the display device is configured to reduce a bias current driving data lines of the display when the enable pulse is provided to a row of the plurality of rows where the gate scan driver of the row is configured to provide a gate enable signal of an adjacent row as a gate enable signal for the row.

15. The display device of claim 1, wherein the predetermined grouping of rows indicates a first region of the display area containing rows of pixels grouped at a first frequency, and a second region of the display area containing rows of pixels grouped at a second frequency.

16. A method of operating a display device, comprising:
at a display driver integrated circuit (DDIC) of a display device, where the display device comprises a display area comprising a plurality of pixels arranged in a plurality of rows each having a respective gate line coupled to a respective gate scan driver circuit, receiving data indicating a grouping of rows of the display area;
at the DDIC, configuring gate scanning signals based on the grouping of rows, wherein values of the gate scanning signals are timed based on a timing of an enable pulse provided by a gate scan line sequentially to gate scan driver circuits of the plurality of rows of the display area;
at the DDIC, configuring a timing of selection pulses based on the grouping of rows and the timing of the enable pulse provided by the gate scan line; and
operating the display by providing the enable pulse sequentially to the plurality of rows via the gate scan line, in conjunction with the configured gate scanning signals and selection pulses, wherein each gate scan driver circuit coupled to a gate line of a respective row of the plurality of rows is configured to selectively provide the enable pulse provided by the gate scan line or a gate enable signal of a gate line of an adjacent row of the plurality of rows as a gate enable signal to the gate line of the respective row, based upon at least a portion of the configured gate scanning signals provided via one or more gate control lines of a plurality of gate control lines.

17. The method of claim 16, wherein the gate scanning signals are configured to change over time based upon a current row receiving the enable pulse from the gate scan line.

18. The method of claim 16, wherein:
the plurality of gate control lines includes n gate control lines, and wherein the plurality of rows is divided into sets of n rows each, wherein each gate scan driver circuit of a set of n rows is connected to a respective gate control line of the n gate control lines; and
wherein the gate scanning signals indicate a number and a position of a group of rows of the grouping of rows within a set of n rows associated with a current position of the enable pulse.

19. The method of claim 16, wherein each gate scan driver circuit comprises circuitry configured to pass through the enable pulse provided by the gate scan line or the gate enable signal of the gate line of the adjacent row.

20. The method of claim 16, further comprising, at the DDIC, configuring a shifting frequency of the enable pulse provided by the gate scan line, where the shifting frequency is shortened when the enable pulse is provided to a row of the plurality of rows where the gate scan driver of the row is configured to provide a gate enable signal of an adjacent row as a gate enable signal for the row.
